(19) United States
(12) Patent Application Publication
(10) Pub. No.: US 2018/0039930 A1
(43) Pub. Date: Feb. 8, 2018

(54) Real-Time Trade Resource Management System

(71) Applicants: Patrick Thomas, Bristow, VA (US); Hussein Cholkamy, Washington, DC (US); James Meadows, Whitestone, VA (US); Daniel Cook, Washington, DC (US)

(72) Inventors: Patrick Thomas, Bristow, VA (US); Hussein Cholkamy, Washington, DC (US); James Meadows, Whitestone, VA (US); Daniel Cook, Washington, DC (US)

(73) Assignee: Prescient Systems, Inc., Washington, DC (US)

(21) Appl. No.: 15/667,347

(22) Filed: Aug. 2, 2017

Related U.S. Application Data
(60) Provisional application No. 62/370,214, filed on Aug. 2, 2016.

(51) Int. Cl. G06Q 10/06; G06Q 10/04; G06Q 10/10

(52) U.S. Cl. CPC G06Q 10/063114; G06Q 10/06398; G06Q 10/06315; G06Q 10/10; G06Q 10/04

(57) ABSTRACT

A real-time trade resource management system is shown. In a construction site having one or more points of ingress/egress a tracking assembly at each point of ingress/egress is used to determine when workers are first and last observed on the site. Each worker on the site is assigned to a specific contract for the construction project. A server, computer readable medium, and method for managing trade resources is described.

### CROSS-REFERENCE TO RELATED APPLICATIONS

This application claims priority to provisional application Ser. No. 62/370,214 filed Aug. 2, 2016, the disclosure of which is incorporated by reference as if fully set forth herein.

### TECHNICAL FIELD

The embodiments described herein relate to a system, computer-readable medium, and method for the real-time management of trade resources in construction projects.

### BACKGROUND

A construction project involves labor to accomplish a project. To accomplish a large project millions of hours of construction trade-labor (e.g., carpenters, welders, plumbers, and electricians) are involved to complete the different phases of the project. A project can only be accomplished on schedule if the appropriate number of trade-labor resources are on-site at the appropriate point in the construction time-table. Alternatively, not having the appropriate trade-resources on a project-site at the right time can result in schedule over-runs and cost over-runs. Additionally, accurately tracking the trade-resources provides valuable information in contract change-order negotiations and daily reporting requirements on projects.

There are a number of problems that can take place on a construction project whereby actual deployment of trade resources serves as a leading indicator. For example, a sub-contractor may be under-staffing a project using fewer than the number of people required in a particular time period. This may result in a schedule delay that can be costly to the contractor, owner, and/or developer. Alternatively, the subcontractor may not be staffing the project with the required number of people due to delayed material shipments, delayed permits, delayed design information, or delayed completion of work by a preceding trade. All of these will likely result in the project not being completed in a timely manner thereby increasing costs and disputes.

Another problem that occurs on construction sites is poor and inaccurate accounting of historical worker headcount by trade and by time period. Most projects use a self-reporting methodology by subcontractors that is a clear conflict of interest. This methodology results in frequent disputes over trade resources actually deployed especially when used in connection with claims for additional scope or claims for extension of time. Maintaining accurate and defensible trade deployment data results in prompt resolution of cost and time claims and, more importantly, prevents claims from developing.

Another problem that occurs on construction sites is that the contractor may not use the same workers throughout the course of a job. Subcontractors may staff a project initially with one crew then move that crew to another project without notice and without regard to the current project. Both of these circumstances results in inefficiencies and frequently leads to poor workmanship, unsafe conditions, cost overruns, and construction delays.

Another problem that occurs on construction sites is where a worker creates an unsafe condition which results in a safety infraction (even though no one is injured). Safety incidents are events whereby a worker is in fact injured resulting in minor, life threatening or severe injury or death. Measuring safety infractions and safety incidents are a key indicator of how safely a project is being managed and quality control on a project. Too many safety infractions or incidents typically signal a project that will have high worker's compensation claims that leads to higher costs on subsequent projects and eventually schedule and cost overruns.

### BRIEF DESCRIPTION OF THE DRAWINGS

FIG. 1 is a high level overview of the various functionality of certain embodiments of the system described herein.

FIG. 2 is an overview of the access and permissions architecture or certain embodiments of the system described herein.

FIG. 3 is a further overview of the access and permissions architecture of certain embodiments of the system described herein;

FIG. 4 an overview of the web application architecture of certain embodiments of the system described herein.

FIG. 5 is a further overview of the web application architecture of certain embodiments of the system described herein.

FIG. 6 is a still further overview of the web application architecture of certain embodiments of the system described herein.

FIG. 7 is a sample display on a tablet computer of data outputted in some embodiments of the system described herein.

FIG. 8 is an example of corporate data entry screens of certain embodiments of the system described herein.

FIG. 9 is an example of a log-in screen used in certain embodiments of the system described herein.

FIG. 10 is an example of a screen showing functionality for adding or editing a licensee used in certain embodiments of the system described herein.

FIG. 11 is an example of a screen showing functionality for adding or editing a project used in certain embodiments of the system described herein.

FIG. 12 is an example of a screen showing functionality for adding or editing a company used in certain embodiments of the system described herein.

FIGS. 13 A and 13 B are partial views intended to form one complete view when joined at their dividing lines of an example of a screen showing functionality for adding or editing a person used in certain embodiments of the system described herein.

FIGS. 14A and 14B are partial views intended to form one complete view when joined at their dividing lines of an example of a screen showing functionality for adding or editing a project used in certain embodiments of the system described herein.

FIG. 15 is an example of licensee data entry screens used in certain embodiments of the system described herein.

FIG. 16 is an example of a licensee log-in screen used in certain embodiments of the system described herein.

FIG. 17 is an example of a screen that enables editing of administrator settings used in certain embodiments of the system described herein.

FIG. 18 is an example of a screen that enables generating an alert used in certain embodiments of the system described herein.

FIG. 19 is an example of a screen that enables entering financial data used in certain embodiments of the system described herein.

FIG. 20 is an example of a screen that enables a change order used in certain embodiments of the system described herein.

FIG. 21 is an example of a screen that enables entering or editing contacts used in certain embodiments of the system described herein.

FIG. 22 is an example of web app dashboard screens used in certain embodiments of the system described herein.

FIG. 23 is an example of a dashboard screen log-in screen used in certain embodiments of the system described herein.

FIG. 24 is an example of a dashboard screen showing various projects of a particular user that is used in certain embodiments of the system described herein.

FIGS. 25A and 25B are partial views intended to form one complete view when joined at their dividing lines of an example of a project overview dashboard screen used in certain embodiments of the system described herein.

FIG. 26 is an example of a trade overview dashboard screen used in certain embodiments of the system described herein.

FIG. 27 an example of a dashboard screen showing a real time site used in certain embodiments of the system described herein.

FIG. 28 is an example of a dashboard screen showing a screen permitting a user to filter reports used in certain embodiments of the system described herein.

FIG. 29 is an example of a dashboard screen showing functionality used to generate a daily labor report used in certain embodiments of the system described herein.

FIG. 30 is an example of a dashboard screen showing functionality used to generate a trade consistency index report used in certain embodiments of the system described herein.

FIG. 31 is an example of a dashboard screen showing functionality used to generate a trade safety index report used in certain embodiments of the system described herein.

FIG. 32 is an example of dashboard screen showing functionality used to generate an incident/infraction report used in certain embodiments of the system described herein.

FIGS. 33A and 33B are partial views intended to form one complete view when joined at their dividing lines of an example of a dashboard screen showing functionality used to generate an evacuation report used in certain embodiments of the system described herein.

FIG. 34 is an example of a dashboard screen showing functionality used to generate a municipality report used in certain embodiments of the system described herein.

FIG. 35 is an example of dashboard screen showing functionality used to filter change orders used in certain embodiments of the system described herein.

FIGS. 36A and 36B are partial views intended to form one complete view when joined at their dividing lines of an example of a dashboard screen showing functionality used to view a change order in certain embodiments of the system described herein.

FIG. 37 is a dashboard screen showing functionality used for viewing a project's contacts in certain embodiments of the system described herein.

FIG. 38 is a dashboard screen showing user account settings used in certain embodiments of the system described herein.

FIG. 39 is a dashboard screen showing functionality used for emailing a report that is used in certain embodiments of the system described herein.

FIGS. 40A and 40B are partial views intended to form one complete view when joined at their dividing lines of a highlight of the functionality and operation of certain embodiments of the system described herein.

FIG. 41 is sample construction site that employs certain embodiments of the system described herein.

FIG. 42 is an example of a tracking assembly positioned at a point of entrance/egress on a construction site that employs certain embodiments of the system described herein.

### SUMMARY

It has been surprisingly found that a system for tracking trade labor resources deployed on a construction site in real-time as described herein avoids the problems previously described.

A typical construction site has restricted points of entry for workers entering onto the site. All people entering onto a construction site are required to wear personal protective gear including hard hats and other protective equipment for safety reasons. The system described herein uses RFID tags, Bluetooth beacons (or other tracking technology) to track people entering, leaving or being recorded as otherwise being on the construction site, the time that they were first recorded as being on the site and the time that they were last recorded as being on the site. To accomplish this, each worker is assigned a unique RFID tag, Bluetooth beacon (or other tracking device) that is placed in or on their assigned hard hat or on a badge or other wearable item specific to that worker.

RFID, Bluetooth (or other tracking technology) scanners or readers or, in general, a tracking assembly, are located at each point of entry/egress on a construction site. The RFID or Bluetooth scanner or readers are configured in such a way that they can detect a worker's RFID tag or Bluetooth beacon (or other trackable device) and the worker's direction of travel or otherwise confirmation of the presence of the worker on the site. The RFID or Bluetooth scanners or readers (or other trackable device) are attached to a computing device which contains a broadcast antenna or similar electronic communicating device. The computing device logs the signal for the worker, the date and time it was detected, and whether the event logged was an entry, exit or otherwise confirmation of a worker's presence on a site. The computing device transmits this information on a periodic basis via the cellular network, through Wi-Fi, satellite or Ethernet connections over the internet to a server. The computing device is assured continuous operation through a back-up battery power supply and back-up data storage device. The server may also receive the information regarding the entry, exit or otherwise presence of a worker on a site via an Application Program Interface (API) from another server performing access control or other similar services that determine ingress and/or egress to a secure construction site.

Upon receiving the information from the computing device, the server collates the information and creates a time sheet for each worker for that time period and calculates the number of hours spent by particular workers on a particular project per day. The server also determines the extent to which the incurred hours are deviating from the forecasted hours for the particular trade. The system is programmed to send the information or a portion thereof in real-time to a project stakeholder. The system is also programmed to send a notification to a project stakeholder if the incurred hours exceed the budget/allocated hours by a certain threshold. Conversely, the system is also programmed to send a notification to a project stakeholder if the incurred hours are beneath the budget/allocated hours by a certain threshold. It should be understood that the server may receive many data points from the computing device during a particular time period and not all of these points may be relevant to a particular report, inquiry, or alert. As a result, the system is able to filter this information and generate reports, alerts, etc. using the relevant portion thereof. To the extent all data received is relevant, it too can be used.

The server is able to perform the tracking described above because the operator of the system translates each contract with a given specialty (e.g., plumbing) into “trade resources” (i.e., man hours and days for a given worker on the project) and tracks it. The ability to break down a specific trade contract into the required trade resource hours and time period and track it is an important feature of certain of the embodiments described herein.

The server can also determine if the same workers are returning to the project on a day to day basis by determining if the same workers or different workers work on the project every day. This is called determining the “Trade Consistency Index” (TCI). In a preferred embodiment, the TCI is calculated by creating “returning hours” or “R” hours for each trade and dividing the total “R” hours for all trades by the total hours recorded for all trades to create a percentage of “returning” trades. The “R” hours are created by accumulating hours by all trades after each individual tradesperson has accumulated at least 80, 120 or 180 hours. (These hours are presets but the actual hour threshold can be set as determined by the individual licensee.) In other words, the trade person begins to accumulate “R” hours after they have recorded 80, 120, or 180 hours on the project. After the trade person has completed this “orientation” period, they are considered to be familiar with the project and as such are considered “returning” trades. The impact of this measurement is improved project safety (as trades people unfamiliar with a site are statistically proven to be the highest risk to safety), project quality and efficiency.

The server can also determine if the project site is a “safe” site in comparison to other sites with a similar measurement methodology. This is called determining the “Trade Safety Index” (TSI). In a preferred embodiment, the system allows for multiple approaches to determining the TSI as described herein as safety is of high importance to the industry. In the first instance, TSI is calculated by creating “safe hours” for each subcontractor and dividing the total “safe” hours for all trades by the total hours recorded for all trades to create a percentage of “safe” hours or a Trade Safety Index. The “safe” hours are created by deducting hours from the total hours logged for each infraction and incident recorded by the safety people on site. For example, for each safety infraction (whereby a worker has created an unsafe condition, e.g., not wearing protective gear, not being tied off properly, etc.) recorded by the on-site safety personnel, a deduction of 40 hours from the total hours logged by all trades is made. For each incident (whereby a worker is in fact injured at varying levels from first aid to death), a similar increasing deduction of hours is made from the total hours logged by all trades. The accumulative effect of these deductions leaves the total “safe” hours for the project from which a percentage is then created i.e. safe hours/total hours. The impact of this measurement is improved project safety. The actual hours deducted can be adjusted to reflect the specific preferences of the licensee.

In the second instance and in another preferred embodiment, the Trade Safety Index (TSI) is calculated by the server performing certain calculations derived from actual safety related information i.e. infractions, incidents, as in the first instance, but also including certain elements that are additive to the quality of the safety program. That is, proactive measures to improve safety, such as safety meetings, training, or other precautionary measures to create a safer project are actually added to the “safe” hours to boost the TSI for the project. This metric is updated as additional safety or related information is recorded. And in the third instance (and another preferred embodiment), the server also is programmed to receive and reflect alternative safety data and other safety measurements developed by other methodologies via an Application Program Interface (API) from other independent third-party safety or risk management systems. The server also is programmed to send alternative workforce, company or safety related information via an Application Program Interface (API) to other independent third-party safety or risk management systems. For the purposes of this embodiment, the methodology for determining the safety parameters and performance metrics are flexible and can be adjusted to meet the needs of the project. Regardless of the nature and methodology for measuring the safety related metrics, the TSI for a project can stand alone using one of the preceding metrics or another metric may be imported from an independent third-party safety measurement or risk management system.

In addition to tracking trade resources, the system can be expanded to track equipment and materials on the project. Materials and equipment are tracked in the same manner as trade resources (i.e., by affixing tracking technology to the materials (or its packaging) and equipment). In addition, the system is also capable of tracking site excavation to measure the progress of the removal of soil or debris from a project site. In a preferred embodiment, dump trucks or other soil/debris removing vehicles have tracking technology affixed to them.

In one embodiment, a system for tracking trade labor resources on a construction site in real-time is shown which comprises: a construction site having one or more points of access; a tracking assembly located at each of the one or more points of access; a computing device connected to the tracking assembly wherein the computing device is connected to a communicating device for transmitting information to a server; a server located remotely from the computing device for receiving information from the computing device; at least one contract for providing construction services on a project; wherein each worker working on the project is assigned to at least one contract; wherein each worker entering the construction site is given a unique electronic identifier; wherein the tracking assembly is configured to detect the date and time at which each worker is first observed on the construction site; wherein the tracking assembly is configured to detect the date and time at which each worker is last observed on the construction site; wherein the computing device collates the information detected by the tracking assembly and transmits said information to the server; wherein the server receives the information from the computing device and processes said information; wherein the server distributes a portion of the information in real-time to a predetermined party; and wherein the server processes said information and distributes a portion of the information in real-time to compare whether the trade resources incurred on the site on a particular date or range of dates meet, exceed, or fall short of a predetermined threshold. In another embodiment, the server processes said information and distributes a portion of the information in real-time to compare whether the trade resources for a specific contract incurred on a particular date or range of dates meet, exceed, or fall short of a predetermined threshold. In a further embodiment, the server sends a notification to a predetermined party if the trade resources on site or for a specific contract exceed the predetermined threshold by a specified amount or if the trade resources fall short of a predetermined threshold by a specified amount.

In another preferred embodiment, the server further identifies each worker who works on the project on a day to day basis so as to determine a trade consistency index. In a still further embodiment, safety infraction and incident information is inputted and the server compares trade resource hours on a job to safety infractions to determine a trade safety index.

In another preferred embodiment, the server is able to process certain elements of artificial intelligence through algorithms that can predict schedule delays and the duration of the delays, that can predict unsafe conditions (TSI) and poor work quality (TCI), and can learn and adjust trade resource requirements based on actual performance on the current project being recorded or from historical data from other projects of similar type and scale. Actual hours recorded coupled with actual field observations of work completed and in place can lead to a recalibration of the plan or forecast. This is computed by simply adjusting the forecast to reflect actual percentage of work in place. For example, if the forecast indicates the hours recorded to date should be 1000 which represents 50% completion, but the actual completion is 60%, by entering the actual completion percentage to date will recalibrate the forecast to reflect better than expected productivity or less than expected productivity. The value in this flexibility and ease of use is to keep the forecast relevant to the managing team.

In another preferred embodiment, the server stores timesheets for each worker and this historical data is available to all project stakeholders for use in settling disputed claims by subcontractors for additional work allegedly required to complete the project that a trade subcontractor alleges is outside of the scope of its original contract.

In another preferred embodiment, the server performs certain calculations that can predict both a project delay and the length of that delay based on the trade forecast requirements and the actual trade resource data collected and reported. Since the projected, planned or forecasted hours to date are known and the actual hours recorded are known, the difference can be calculated. And, since the daily requirements are known, the server can simply divide the total deficit by the daily requirement to determine the number of days the project is behind schedule. This delay can then be communicated via an alert highlighted on the dashboard or via a text message. The threshold for the alert can be set at varying levels and the alerts can be set differently for every subcontractor. This is an important distinction as all trades are not critical at all times on projects. The flexibility to adjust the thresholds during the project is key to effectively managing a project.

In another preferred embodiment, the server performs certain calculations that can determine whether a key trade person is no longer actively engaged in the project thereby putting the project at risk for a successful completion. Subcontractors are often selected based on the specific team members presented and are often named in the contract. The server can be notified to look for certain tracking devices (people) and send an alert if that device has not been seen on the site for any number of days. The actual number of days “not seen” is flexible and can be set at the discretion of the licensee. This information is communicated via an alert highlighted on the dashboard or via a text message.

In another preferred embodiment, the server retains historical data that is available to all project stakeholders for use in settling disputed claims by subcontractors for additional time to complete a project allegedly required due to circumstances beyond its control such as weather, that a trade subcontractor alleges was the causing event of its inability to complete the project within the contractual time requirements.

In another preferred embodiment, the server accumulates certain information at the end of each month that is formatted into a monthly report that records for historical purposes trade registration, trade deployment, average deployment per day, required headcount per day, and other information that memorializes the project progress during that time period. This information is communicated via email at a predetermined period each month.

In another preferred embodiment, the server accumulates and maintains certain historical resource deployment information in chronological order to allow for review and searching by all stakeholders. Information includes alerts (including alert status), comments by all stakeholders, and data included in monthly reports.

In another preferred embodiment, the server provides to mobile and other internet enabled devices specific worker images that allows for the affirmative identification of workers with visual identification, specific information regarding each worker's specific time and attendance as well as personal information that will serve to enhance the security of the project.

In another preferred embodiment, the server maintains a directory for all workers that includes the identification of the worker, specific information regarding each worker's specific time and attendance as well as personal information. This information can be accessed by all authorized stakeholders.

In another preferred embodiment, the server accumulates and maintains certain historical resource deployment information to allow for developing future projections for similar type projects. This data is also utilized to report the accumulative effect of an entire firm's workload across all projects to allow for resource leveling.

In another preferred embodiment, the server accumulates and maintains certain historical resource deployment information for specific subcontractors to allow for the comparison of a subcontractor's performance on various projects, to allow for the viewing of workload of a specific subcontractor, and to make comparisons of subcontractor performance on projects of similar type and scope.

In another preferred embodiment, the server accumulates and distributes historical resource deployment information for specific subcontractors in various formats and is delivered weekly or monthly or in other flexible time periods.

In another preferred embodiment, the system also tracks materials used on the project. In yet another embodiment, the system tracks equipment used on the project. In yet another embodiment, the system tracks the excavation progress on the project to measure the progress of the removal of soil or debris from a project site.

The system described herein is flexible and may be employed in construction projects that have pre-existing tracking technology at the point(s) or ingress/egress. In such a situation, information can be imported into the server via an Application Program Interface. As a result, in another embodiment, a system for tracking trade labor resources on a construction site in real-time is shown which comprises: a server located remotely from the construction site configured to receive information from an application program interface; at least one contract for providing construction services on a project; wherein each worker working on the project is assigned to at least one contract; wherein each worker entering the construction site is given a unique electronic identifier; wherein the application program interface contains information regarding the date and time at which each worker is first observed on the construction site; wherein application program interface contains information regarding the date and time at which each worker is last observed on the construction site; wherein the server receives the information from the application program interface and processes the information; wherein the server distributes a portion of the information in real-time to predetermined parties and wherein the server processes said information and distributes a portion of the information in real-time to compare whether the trade resources incurred on the site on a particular date or range of dates meet, exceed, or fall short of a predetermined threshold. In another embodiment, the server processes said information and distributes a portion of the information in real-time to compare whether the trade resources for a specific contract incurred on a particular date or range of dates meet, exceed, or fall short of a predetermined threshold. In a further embodiment, the server sends a notification to a predetermined party if the trade resources on site or for a specific contract exceed the predetermined threshold by a specified amount or if the trade resources fall short of a predetermined threshold by a specified amount.

In another embodiment, a non-transitory computer readable medium for a system for tracking trade resources on a construction site in real time is shown. The non-transitory computer readable medium having thereon resident at least one program comprising instructions, which instructions, when executed by a computer processor perform the steps of: causing a server to process information received from a computing device located at a construction site wherein the construction site has one or more points of access; a tracking assembly located at each of the one or more points of access; a computing device connected to the tracking assembly wherein the computing device is connected to a communicating device for transmitting information to the server; the server located remotely from the computing device for receiving information from the computing device; at least one contract for providing construction services on a project; wherein each worker working on the project is assigned to at least one contract; wherein each worker entering the construction site is given a unique electronic identifier; wherein the tracking assembly is configured to detect the date and time at which each worker is first observed on the construction site; wherein the tracking assembly is configured to detect the date and time at which each worker is last observed on the construction site; wherein the computing device collates the information detected by the tracking assembly and transmits said information to the server; wherein the server receives the information from the computing device and processes said information; wherein the server distributes a portion of the information in real-time to a predetermined party; and wherein the server processes said information and distributes a portion of the information in real-time to compare whether the trade resources incurred on the site on a particular date or range of dates meet, exceed, or fall short of a predetermined threshold. In a another embodiment, the non-transitory computer readable medium causes the server to process said information and distribute a portion of the information in real-time to compare whether the trade resources for a specific contract incurred on a particular date or range of dates meet, exceed, or fall short of a predetermined threshold. In a further embodiment, the non-transitory computer readable medium causes the server to send a notification to a predetermined party if the trade resources on site or for a specific contract exceed the predetermined threshold by a specified amount or if the trade resources fall short of a predetermined threshold by a specified amount.

In another preferred embodiment, non-transitory computer readable medium having thereon resident at least one program comprising instructions, which instructions, when executed by a computer processor perform the steps of enabling the server to identify each worker who works on the project on a day to day basis so as to determine a trade consistency index. In a still further embodiment, the non-transitory computer readable medium having thereon resident at least one program comprising instructions, which instructions, when executed by a computer processor perform the steps of enabling the server to receive inputted safety infraction and incident information and compare trade resource hours on a job to safety infractions to determine a trade safety index. It should be understood that all functionality described herein for the server can be embodied in instructions in a non-transitory computer readable medium such that, when executed, the instructions would cause a computer to perform the described functionality. Thus, in the embodiment described above wherein the server uses the API to receive data, the non-transitory computer readable medium having thereon resident at least one program comprising instructions, which instructions, when executed by a computer processor perform the step of causing the server to operate using data received from the API.

In another embodiment, a server configured to receive the information from a computing device is shown wherein the server processes said information; wherein the server processes said information and translates and distributes it in real-time to a predetermined party; and wherein the server processes said information and translates and distributes the information in real-time to compare whether the trade resources incurred on the site on a particular date or range of dates meet, exceed, or fall short of a predetermined threshold. In a further embodiment, the server processes said information and translates and distributes the information in real-time to compare whether the trade resources for a specific contract incurred on a particular date or range of dates meet, exceed, or fall short of a predetermined threshold. In another embodiment, the server sends a notification to a predetermined party if the trade resources exceed the predetermined threshold by a specified amount or if the trade resources fall short of a predetermined threshold by a specified amount.

In another embodiment, a method of tracking trade resources in real-time on a construction site is shown which comprises: determining a timeline for a construction project on a construction site that comprises at least one contract for providing construction services on the project; allocating trade resources to each of the at least one contracts on the construction project; tracking the trade resources incurred on the project on a periodic basis; and notifying a predetermined party if the trade resources exceed a predetermined threshold by a specified amount or if the trade resources fall short of a predetermined threshold by a specified amount; wherein the construction site has one or more points of access; and wherein a tracking assembly is located at each of the one or more points of access; and wherein a computing device is connected to the tracking assembly; and wherein the computing device is connected to a communicating device for transmitting information to a server; and wherein the server is located remotely from the computing device for receiving information from the computing device; and wherein each worker working on the project is assigned to at least one contract; and wherein each worker entering the construction site is given a unique electronic identifier; and wherein the tracking assembly is configured to detect the date and time at which each worker is first observed on the construction site; and wherein the tracking assembly is configured to detect the date and time at which each worker is last observed on the construction site; and wherein the computing device collates the information detected by the tracking assembly and transmits said information to the server; and wherein the server receives the information from the computing device and processes said information and distributes a portion of the information and compares whether the trade resources incurred on a particular date meet, exceed, or fall short of a predetermined threshold.

In another preferred embodiment, the method comprises processing said information and distributing a portion of the information in real-time to compare whether the trade resources for a specific contract incurred on a particular date or range of dates meet, exceed, or fall short of a predetermined threshold. In still another embodiment, the method comprises sending a notification to a predetermined party if the trade resources on site or for a specific contract exceed the predetermined threshold by a specified amount or if the trade resources fall short of a predetermined threshold by a specified amount. It will be understood that the method described herein may encompass all steps performed by the server as well the steps taken to program the server and input data into the server.

In another preferred embodiment, the method comprises identifying each worker who works on the project on a day to day basis so as to determine a trade consistency index. In another preferred embodiment, the method comprises identifying each worker who works on the project on a day to day basis so as to determine a trade consistency index.

In still another embodiment, the method comprises receiving safety infraction and incident information and the comparing trade resource hours on a job to safety infractions to determine a trade safety index. In yet another embodiment, the method comprises predicting a schedule delay and the duration of the schedule delay. In another embodiment, the method involves determining a project delay and the length of that delay based on the trade forecast requirements and the actual trade resource data collected and reported. In still another embodiment, the method involves communicating the delay to a predetermined party via an alert.

In another embodiment, the method involves determining whether a key trade person is participating on a project. In still another embodiment, the method involves providing images of workers to permit visual identification of on-site workers. In yet another embodiment, the method involves maintaining a directory of all workers on a project. In still another embodiment, the method involves tracking materials used on the project. In another embodiment, the method involves tracking equipment used on the project. In yet another embodiment, the method involves tracking the progress of excavation on a project.

In an alternate embodiment, the method involves receiving information about when a worker is first observed on a site and last observed on a site via an application program interface.

In another embodiment, the method comprises determining a trade consistency index on a periodic basis. In a still further embodiment, the method comprises determining a trade safety index on a periodic basis.

### DETAILED DESCRIPTION OF ILLUSTRATIVE EMBODIMENTS

In a preferred embodiment, the system described herein is a web-based application that will give certain participants in a construction project access to real-time data regarding the number of on-site man-hours that were originally planned versus those currently expended. This enables users to proactively address problems before they occur. The system is preferably robust and enables participants to track trade consistency and safety data, change-order status, and weather and site conditions.

Access to the foregoing data is preferably limited to certain recipients. In a preferred embodiment, the recipients are authorized to receive some or all of the data collected by the system by virtue of registering for access.

In a preferred embodiment, there may be different levels of registration. For example, an administrator of the system may have access to all data. In contrast, a registered user may have access to a portion of certain data. For example, registration may limit a user's access to construction projects affiliated with a particular user.

In a preferred embodiment, the system will be fully-functional through all common web browsers.

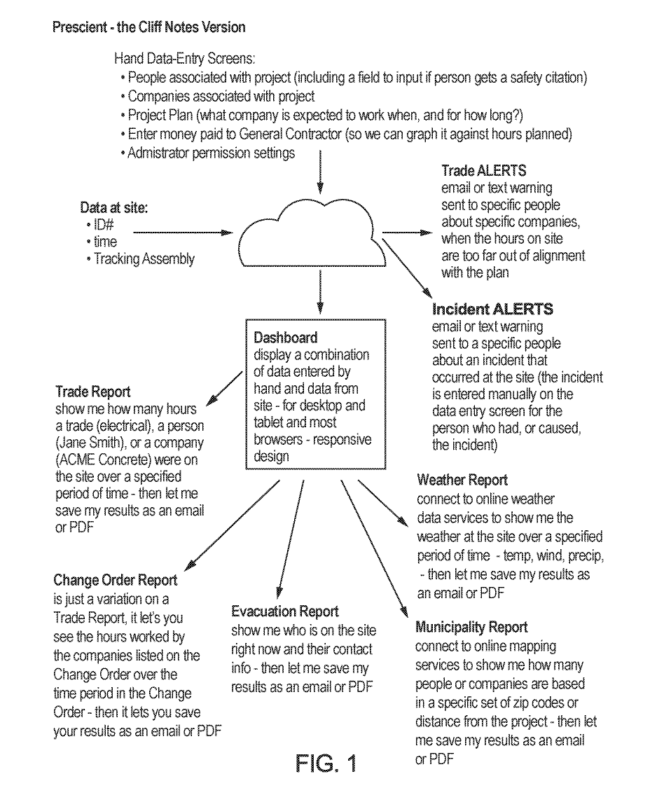

Referring now to the Figures, FIG. 1 is a high level overview of the various functionality of certain embodiments of the system described herein. A server or computing device indicated by the cloud receives data from hand-data entry screens and RFID, Bluetooth or other tracking technology data at a construction site. In a preferred embodiment, the server is a relational database. The server collects and processes data received from the hand-data entry screens as well as RFID, Bluetooth or other tracking technology data collected at the site. The server is programmed so that it can display various items of information in a dashboard format. In a preferred embodiment, the display is for a desktop computer, a tablet computer, or other mobile device. In other preferred embodiments, the server displays data to a webpage or an app for a smartphone.

The server is programmed to generate a variety of reports in certain embodiments. In a preferred embodiment, one such report is a trade alert. In a preferred embodiment, a trade alert is an email or text warning sent to specific people about specific companies when the hours on site are outside of a predetermined threshold for a construction plan or forecast.

In another preferred embodiment, the server can provide an incident alert. In a preferred embodiment, an incident alert is an email or text warning sent to specific people about an incident that occurred at the site. In a preferred embodiment, data regarding the incident is entered manually on a data entry screen for the person who had or caused the incident.

In another preferred embodiment, the server can provide a key person alert. In a preferred embodiment, the absence of a key person from the project can put the project's completion date, its quality or safety in jeopardy. This information is communicated via an alert highlighted on the dashboard or via a text message.

In another preferred embodiment, the server can provide a schedule delay alert. In a preferred embodiment, the server can perform certain calculations to determine if the schedule will be delayed beyond an acceptable threshold. This delay is communicated via an alert highlighted on the dashboard or via a text message.

In another preferred embodiment, the server can provide a trade report. In a preferred embodiment, a trade report shows how many hours a trade, a person, a company, or a combination thereof, were on a construction site over a specified period of time.

In another preferred embodiment, the server can provide a weather report. In a preferred embodiment, the server connects to online weather data services to show the weather at a construction site over a specified period of time.

In another preferred embodiment, the server can provide a change order report. In a preferred embodiment, this report shows the hours worked by the companies listed on the change order over a period of time specified in the change order.

In another preferred embodiment, the server can provide an evacuation report. This report shows who is on the site at a given moment in time and as well as their native language and contact information.

In another preferred embodiment, the server can provide a daily trade report. This report shows what subcontractor and specifically what trades have been on the site for any given day including the first time the worker was observed and the last time the worker was observed and the accumulated hours for that day.

In another preferred embodiment, the server can provide a weekly trade report. This report shows specifically what subcontractor and specifically how many trades have been observed on the site for any given week and the accumulated number of workers for that week.

In another preferred embodiment, the server can provide a municipality report or work force demographic report. This report connects to online mapping services and shows how many people or companies are based in a specific set of zip codes or distance from the project as well as other variables such as ethnicity or union affiliates.

In a preferred embodiment, the system allows a user to save the results shown in one or more reports as an email or pdf.

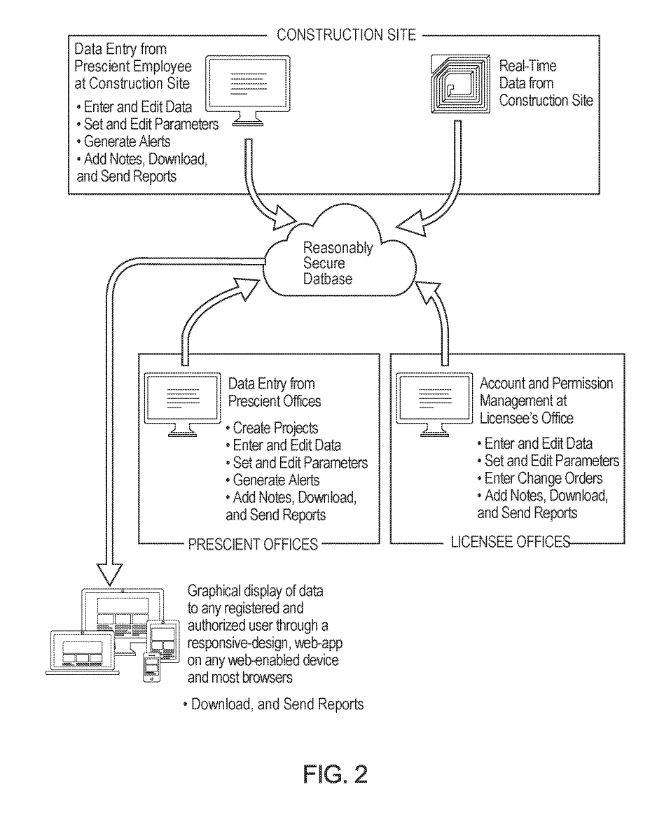

FIG. 2 is an overview of the access and permissions architecture of certain embodiments of the system described herein. In a preferred embodiment, the entity that runs the system described herein is separate from the entity or entities that are managing construction projects tracked by the system. This entity that runs the system is termed “Prescient” in the attached figures for the assignee of the instant application. Prescient may host the server or servers operating the system. Alternatively, Prescient may contract with third party providers (e.g, Microsoft) for server capacity. In this latter embodiment, Prescient provides the third party with a computer program to run the described system on the third party's server(s). In another embodiment, the entity that runs the server is the same entity that is managing a construction project that the server tracks.

As shown in FIG. 2, the server (termed “reasonably secure database” in the Figure) receives data from a variety of sources. In some embodiments, Prescient may have an employee that enters data at the construction site. In addition, the server may receive RFID or Bluetooth or other tracking technology or an Application Program Interface (API) data from the construction site. Data entry may take place from Prescient's offices. In addition, data entry may take place at a licensee's offices. In certain preferred embodiments, a “licensee” is an authorized, registered user of the system.

The various entities involved in sending data to Prescient's server may perform a variety of tasks. This includes entering and editing data, setting and editing parameters, generating alerts, adding notes, downloading reports, sending reports, creating projects, and entering change orders.

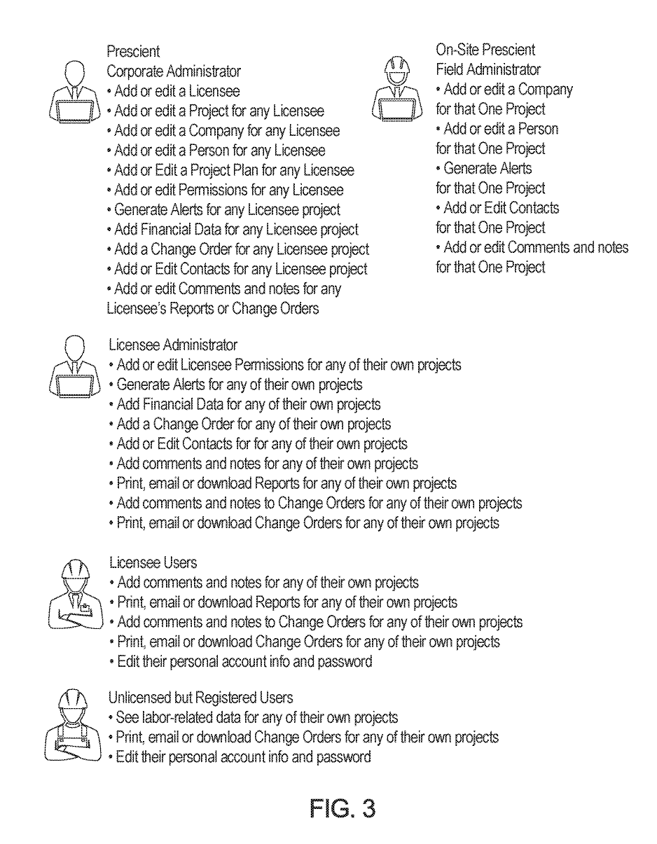

FIG. 3 is a further overview of the access and permissions architecture of certain embodiments of the system described herein. As shown in FIG. 3, there may be various levels of access granted to the system maintained by Prescient. For example, a Prescient administrator may access, add, delete, or edit all licensee data in the system. A licensee administrator may access and add, delete, or edit all data for that particular licensee. A licensee user, in contrast, may have permission to add, delete, or edit a more limited sub-set of data. An unlicensed but registered user may have the ability to add or edit their personal information and see a limited amount of data related to a construction project for a particular licensee. The amount of access each individual has to the data in the system is controllable by Prescient and can be changed at any point of time.

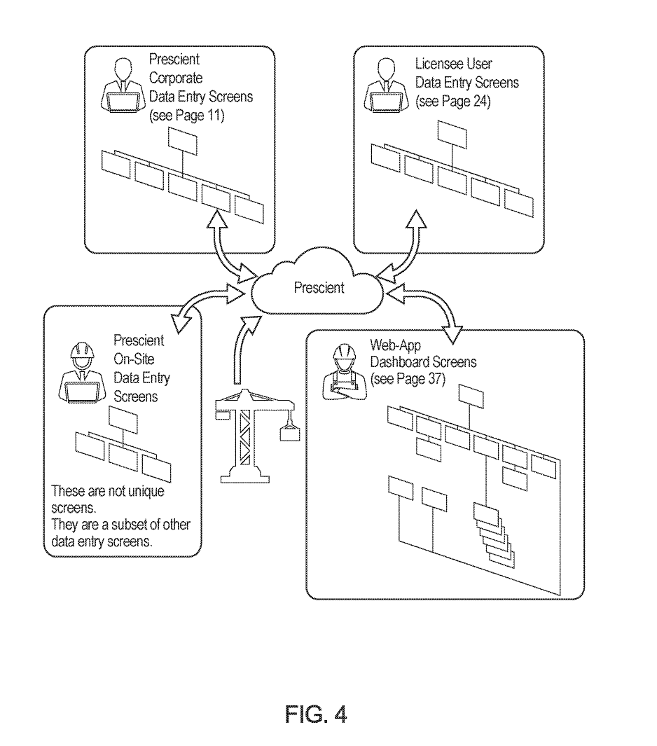

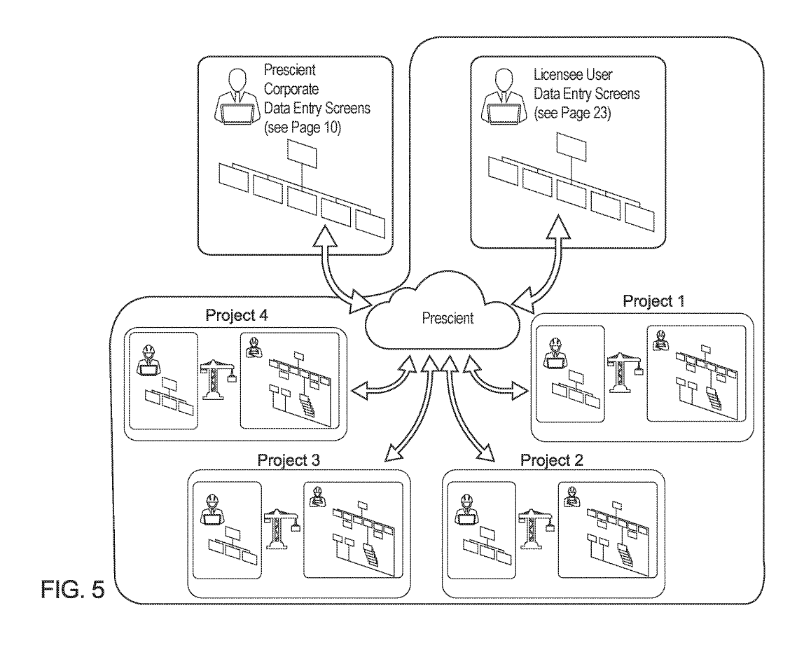

FIG. 4 an overview of the web application architecture of certain embodiments of the system described herein. In a preferred embodiment, the Prescient administrator enters the initial licensee and project data. Once the project is specified, licensee rights are created and the particular project is entered into the database. Prescient, the Licensee, the Prescient project manager and anybody else given authorization can enter and update information related to the project.

FIG. 5 is a further overview of the web application architecture of certain embodiments of the system described herein. As is made clear in FIG. 5, a given licensee may have multiple projects in the system. The rights given to various entities to add, delete, modify or access data may vary for each project.

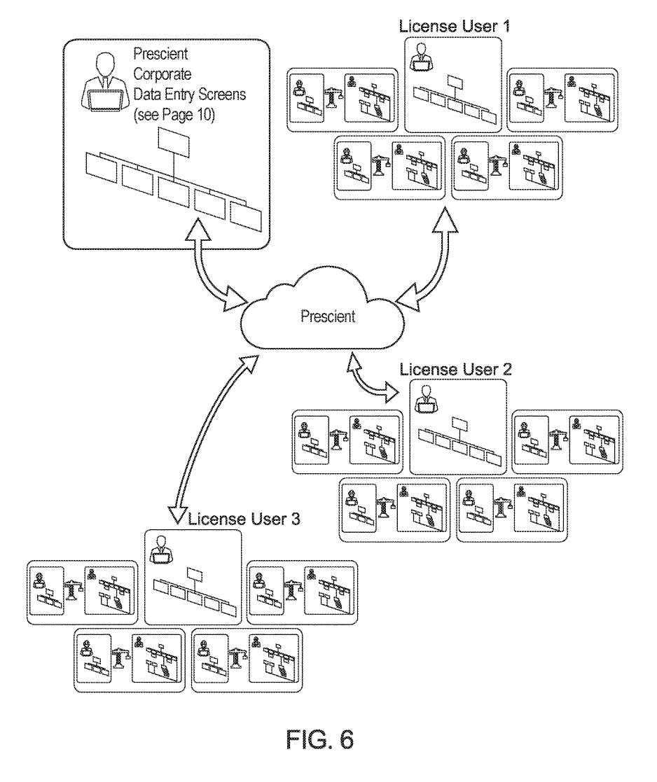

FIG. 6 is a still further overview of the web application architecture of certain embodiments of the system described herein. The Prescient administrator manages the data for the projects of multiple licensees. However, each licensee is only granted access to the data for that particular licensee. A licensee may have access to only one project or many. The allowable permissions are flexible to meet the needs of different organizations.

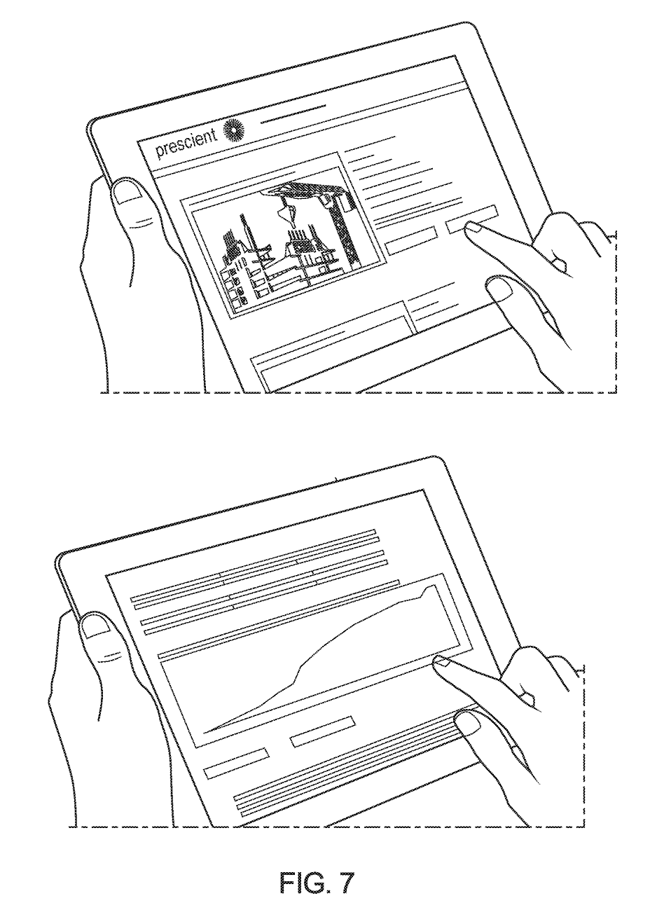

FIG. 7 are sample displays on a tablet computer of data outputted in some embodiments of the system described herein. In a preferred embodiment, the display is capable of being viewed on a tablet computer. However, viewing the display on a desktop computer, a tablet computer, or a smartphone app or any other internet enabled device is also preferred.

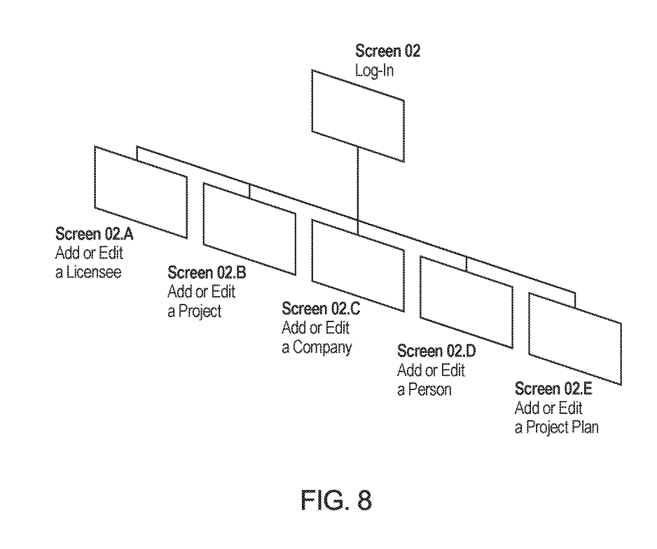

FIG. 8 is an example of sample data entry screens for the operator of the system for certain embodiments of the system described herein. This figure shows high level functionality for the Prescient data entry screens. In a preferred embodiment, Prescient has the ability to add or edit a licensee; add or edit a project; add or edit a company; add or edit a person; or add or edit a project plan or forecast.

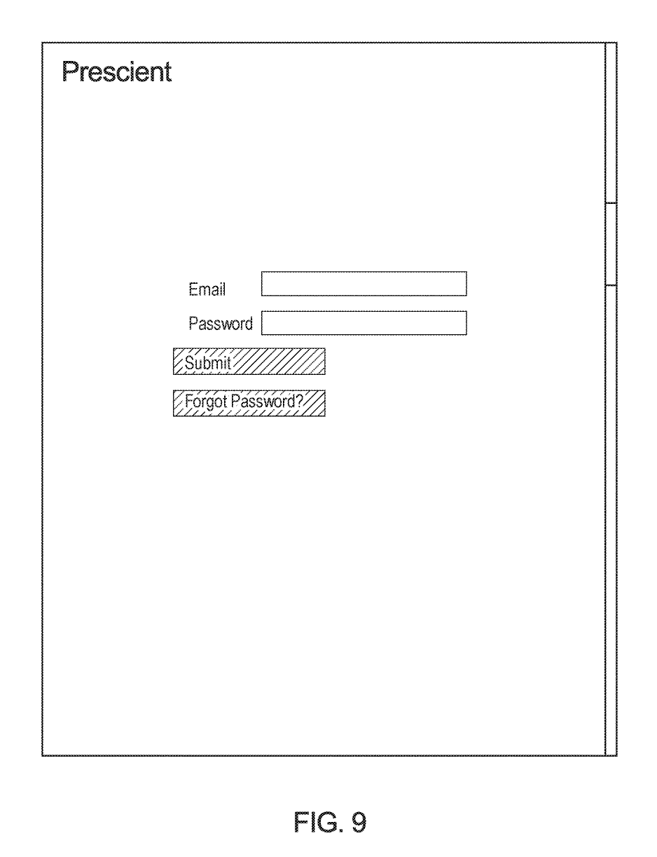

FIG. 9 is an example of a log-in screen used in certain embodiments of the system described herein. In a preferred embodiment, the user's email address can be used in place of a unique “user name”. Alternatively, a username may be created by Prescient or specified by the user. Password protection for the system is also preferably included. The password may be initially generated by Prescient. However, the user will have the ability to create a substitute password after an initial log-in. In a preferred embodiment, password recovery is also permitted by clicking on a “Forgot Password” icon.

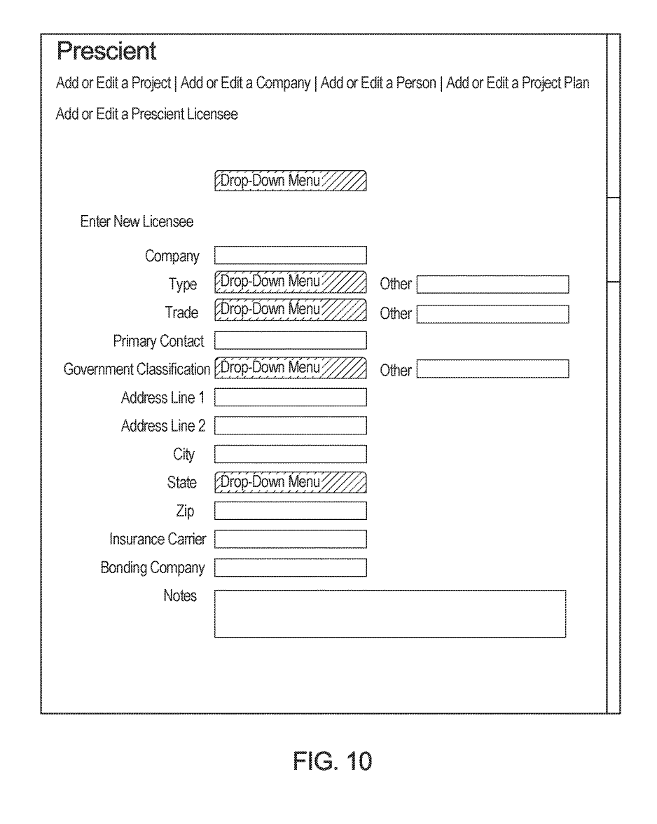

FIG. 10 is an example of a screen showing functionality for adding or editing a licensee used in certain embodiments of the system described herein. In a preferred embodiment, the licensee is a company that is authorized to use the system described herein to manage a construction project. In a preferred embodiment, the ability to add a new licensee is limited to the operator of the system. Previously entered licensees may be located via a drop-down menu. The system also permits information about a licensee to be edited or deleted.

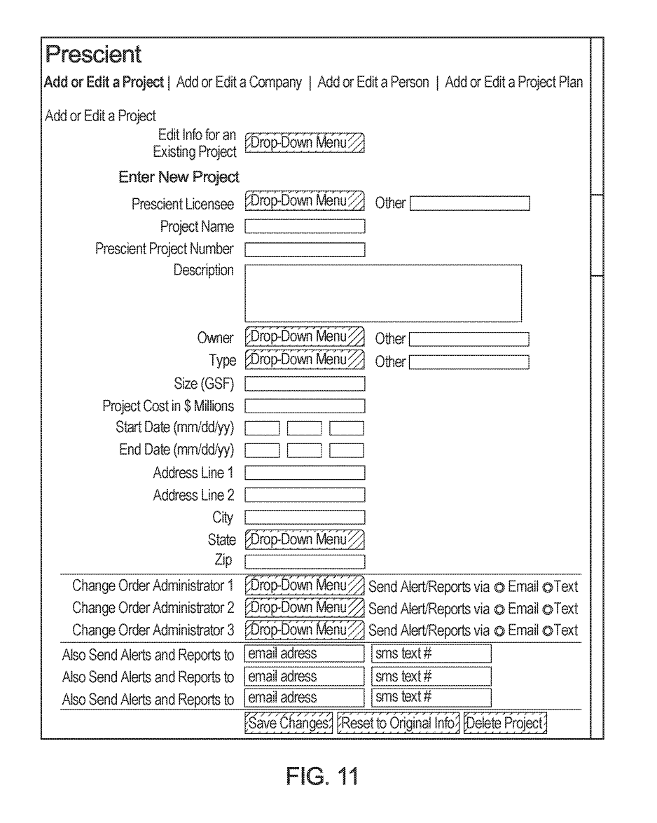

FIG. 11 is an example of a screen showing functionality for adding or editing a project used in certain embodiments of the system described herein. FIG. 11 is an example of a screen showing functionality for adding or editing a project for a particular licensee. In a preferred embodiment, the project can be a commercial construction project (e.g., an office building, multi-use, retail, or institutional construction project), an industrial project (processing plant, refinery, chemical plant), or a public works project (highway, bridge, water treatment plant). In a preferred embodiment, the ability to add a new project is limited to the operator of the system unless authorized by the operator. Previously entered projects may be located via a drop-down menu. The system also permits information about a project to be edited or deleted.

In a preferred embodiment, the licensee has the ability to specify under what conditions an alert will be sent by subcontractor as well as the recipients of the alert. In a preferred embodiment, the alert will be sent when a project or subcontractor has deviated too far from the planned or forecasted trade requirements, the established schedule is in jeopardy, or a key person has been removed from the project.

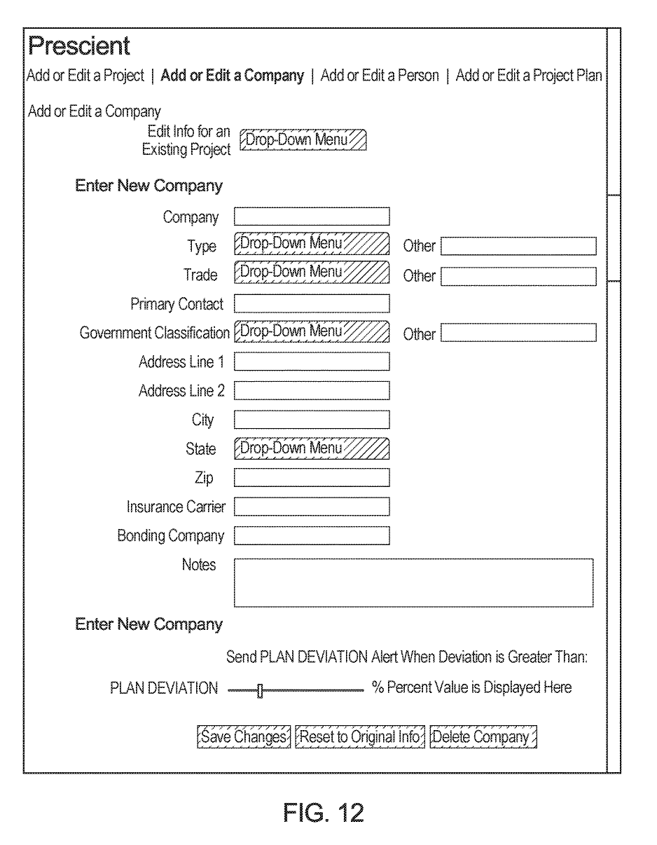

FIG. 12 is an example of a screen showing functionality for adding or editing a company used in certain embodiments of the system described herein. In a preferred embodiment, a company is an entity working on-site on a construction project. This will generally include the General Contractor of a project as well as all sub-contractors. In a preferred embodiment, the ability to add a new company is limited to the operator of the system or those authorized by the operator. Previously entered companies may be located via a drop-down menu. The system also permits information about a company to be edited or deleted by the operator or those authorized by the operator. The system permits a company to be deleted from the database as well.

In a preferred embodiment, this functionality includes the ability to set an alert by specifying the percent of hours that the company must deviate from the project plan or trade forecast such that an alert will be sent. For example if a user sets the threshold parameter at 10%, and at some point during the construction project the company has used only 89% of the hours anticipated by that date (or exceeds the anticipated hours by 111%), an alert will be sent. These alerts are flexible as the alert parameters for one subcontractor can change from that of another subcontractor. Alerts can be simply illustrated or alerts can be communicated via email and/or text messages to any project stakeholder.

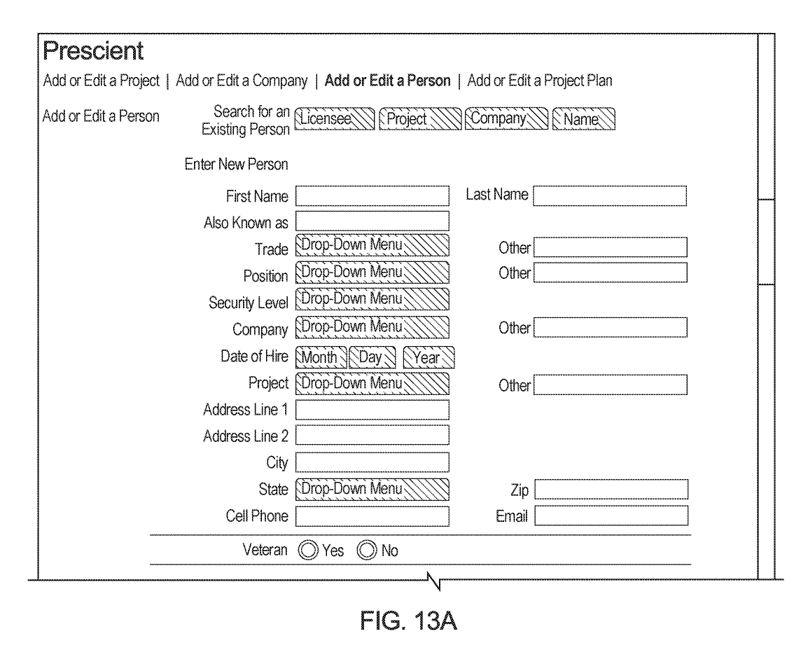

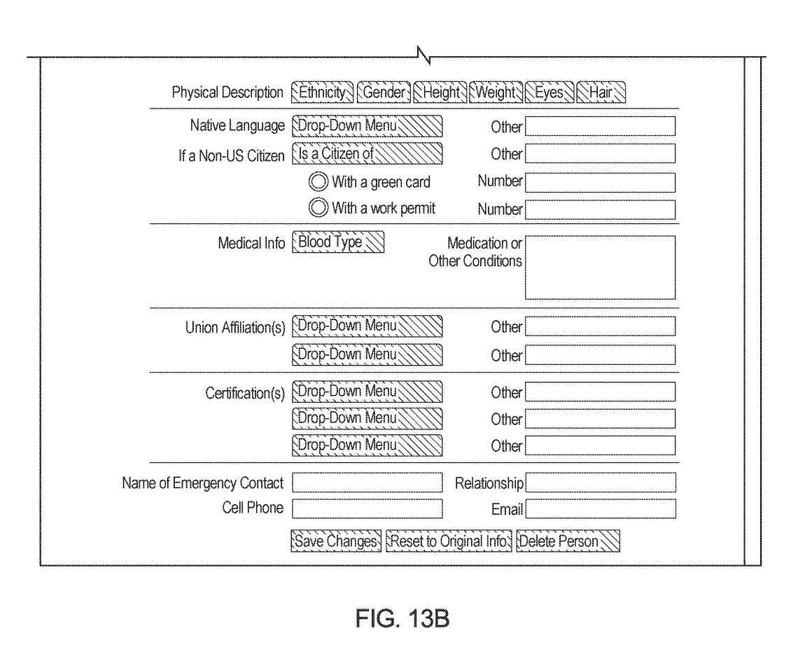

FIGS. 13A and 13B are an example of a screen showing functionality for adding or editing a person used in certain embodiments of the system described herein. In a preferred embodiment, a “person” refers to every person who may need to spend time on the actual construction site as well as any person who may be involved in the design, inspection, ownership project management or day-to-day decision making. In a preferred embodiment, the ability to add, delete or modify the attributes of a new person is limited to those authorized to perform these tasks by the operator of the system. A previously entered person may be located via a drop-down menu. The system permits a person to be deleted from the database as well.

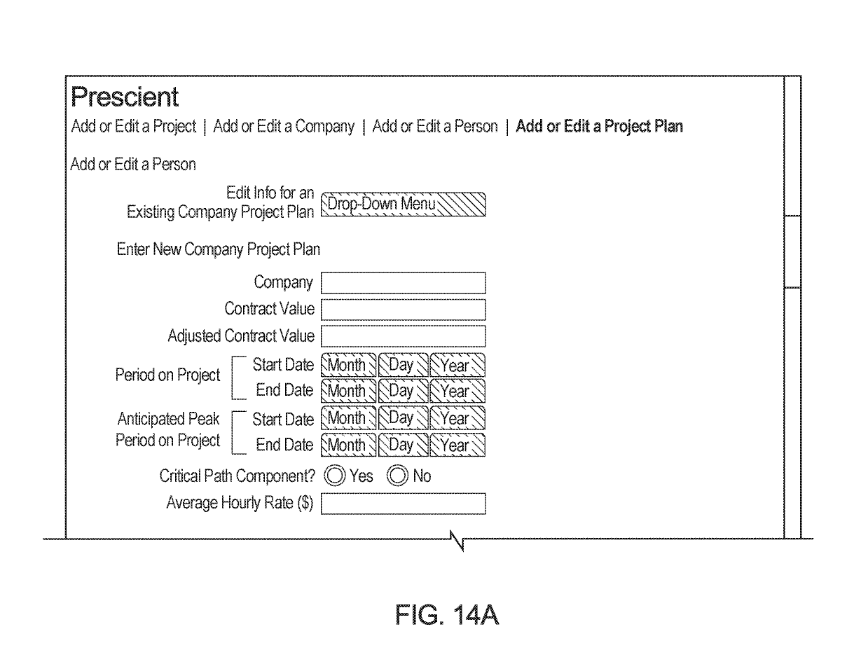

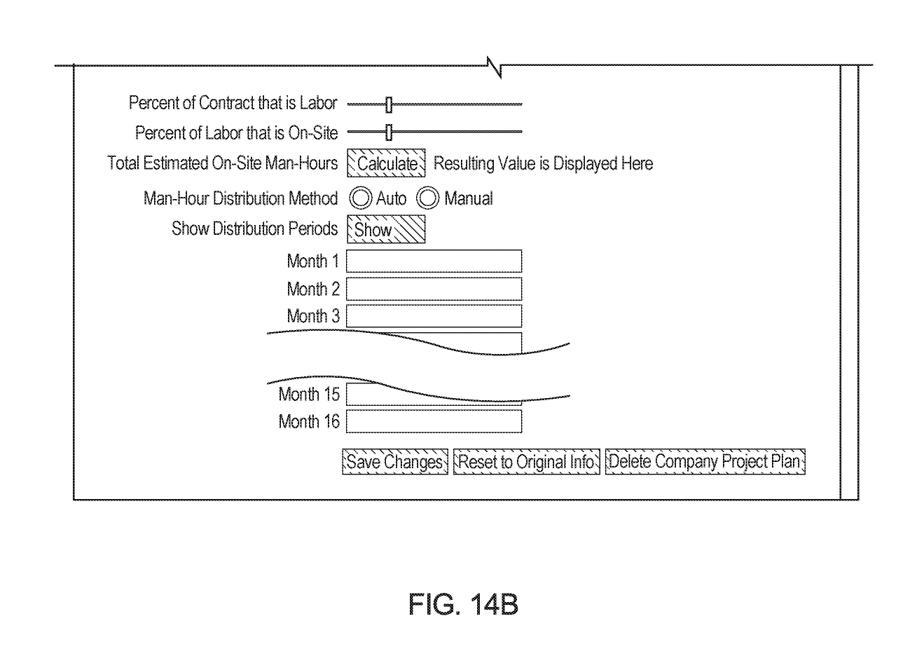

FIGS. 14A and 14B are an example of a screen showing functionality for adding or editing a project trade forecast or plan used in certain embodiments of the system described herein. In a preferred embodiment, a project trade forecast or plan is the project forecast for a specific company. In a preferred embodiment, the plan includes information such as (1) the duration of time that a company is anticipated to be working on a construction project; (2) the amount of on-site man-hours and head count that the company is anticipated to require to do that work; (3) the period when those on-site man-hours or headcount are anticipated to be at peak intensity; and (4) the company's average hourly rate for on-site labor.

In a preferred embodiment, the ability to add, delete or modify the attributes of a trade forecast or plan is limited to those authorized to perform these tasks by the operator of the system. A previously entered project trade forecast or plan may be located via a drop-down menu. The system permits a project trade forecast or plan to be deleted from the database as well. In a preferred embodiment, the system has the ability to generate a bell curve showing the distribution of hours across the duration of the project.

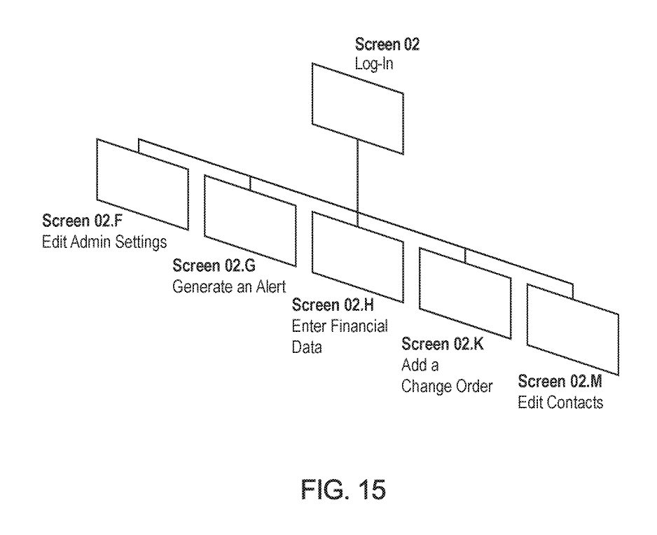

FIG. 15 is an example of licensee data entry screens used in certain embodiments of the system described herein. In a preferred embodiment, there are multiple screens that an authorized licensee may access including a log-in screen, a screen to edit admin settings, a screen to add, edit or delete workers or other project participants, a screen to generate, modify or delete alerts, a screen to enter financial data, a screen to add, modify or delete trade forecast data, a screen to add a change order, and a screen to edit contacts. Other screens may be included for some or all of the licensees or those authorized by the operator.

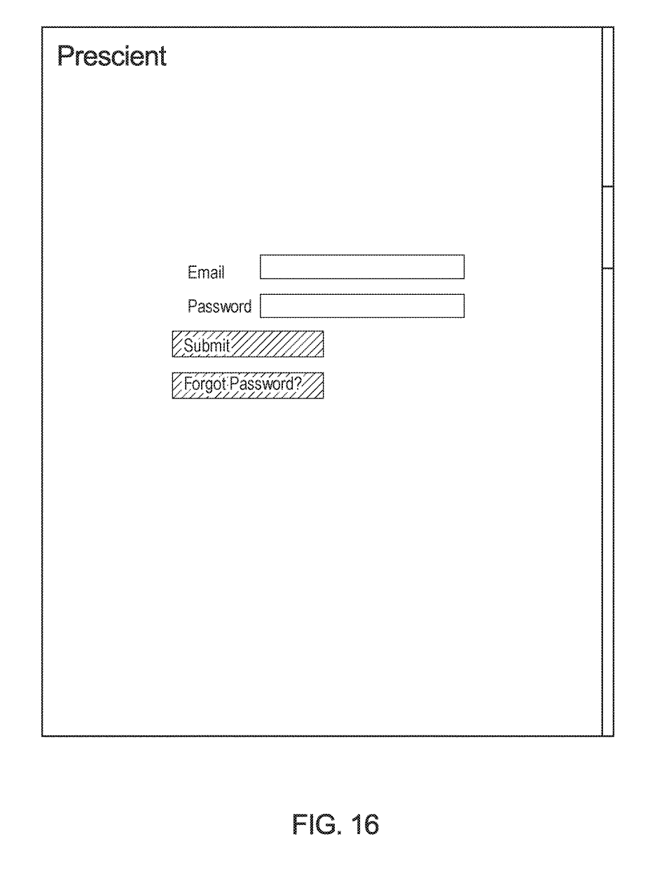

FIG. 16 is an example of a licensee log-in screen used in certain embodiments of the system described herein. In one embodiment, a user may access the system using an email address instead of a unique “user name”. Alternatively, the user or the operator of the system may specify a particular user name for a given user. In another preferred embodiment, the system is password protected. In one embodiment, the initial password for a user will be generated by the operator of the system. In another embodiment, the user has the ability to change the password after initial log-in. Password recovery functionality is also preferably included.

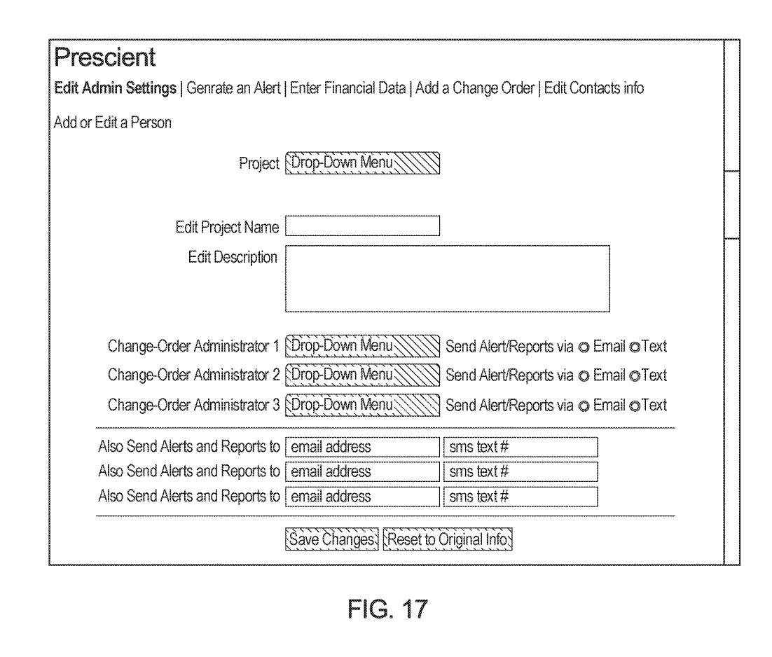

FIG. 17 is an example of a screen that enables editing of licensee administrator settings used in certain embodiments of the system described herein. The screen enables the licensee administrator to edit information for a project of a specific licensee. In preferred embodiment, this information includes: (1) the name or description of the project; (2) the people authorized to add change orders to the system; (3) the people who receive alerts; and (4) how alerts are received. In addition to adding or editing information, information can be deleted as well.

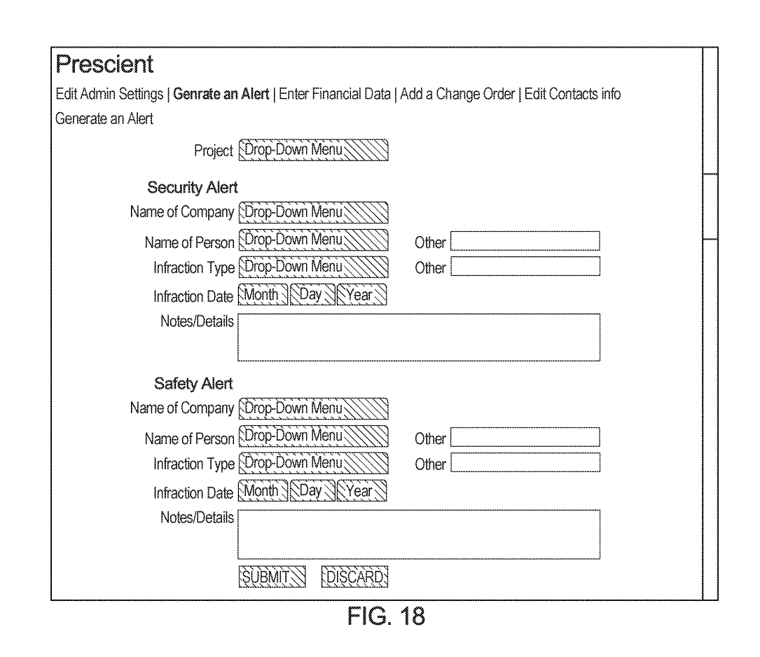

FIG. 18 is an example of a screen that enables generating an alert used in certain embodiments of the system described herein. This screen is preferably used by a licensee administrator to generate a safety or security alert for a specific project. In a preferred embodiment, an alert is a notification sent to an appropriate participant via, e.g., text, email, or both. In another embodiment, additional individuals may be given rights to send out safety and/or security alerts. In another embodiment, an alert can be modified, snoozed or deleted.

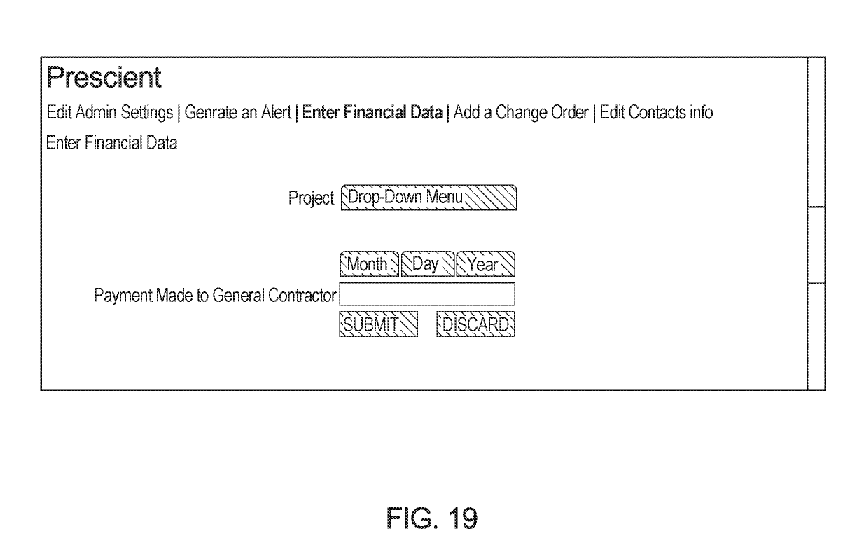

FIG. 19 is an example of a screen that enables entering financial data used in certain embodiments of the system described herein. Preferably, this screen enables a licensee administrator to add data about how much money has been spent on on-site labor on the project. In a preferred embodiment, the system will calculate what percent of a project cost should be determined “labor” costs. In addition, data can be edited or deleted by the licensee administrator.

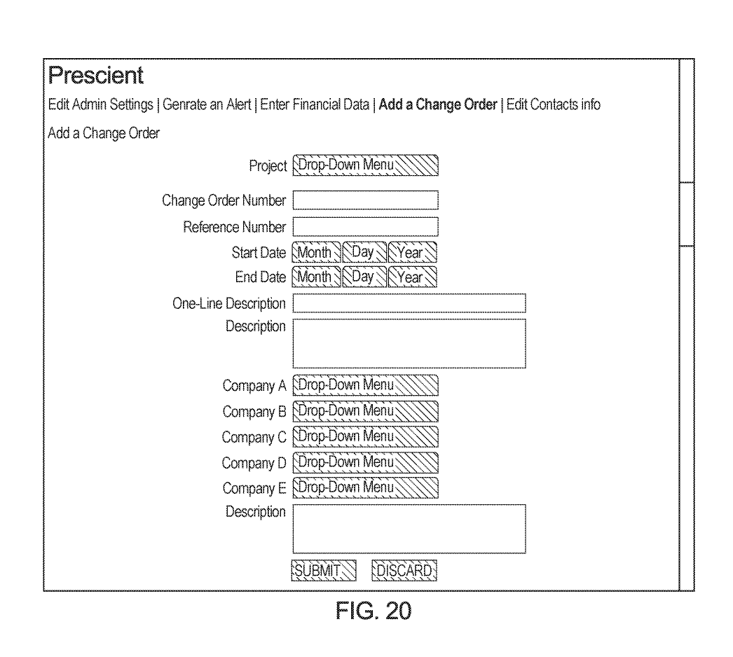

FIG. 20 is an example of a screen that enables the selection and organization of certain trade resource data that provides trade resource forecast and actual recorded trade resource data that assists in the resolution of a change order as referred to in certain embodiments of the system described herein. It should be noted that a licensee may separately track change orders through their own accounting systems. The system described herein does not necessarily replace those systems.

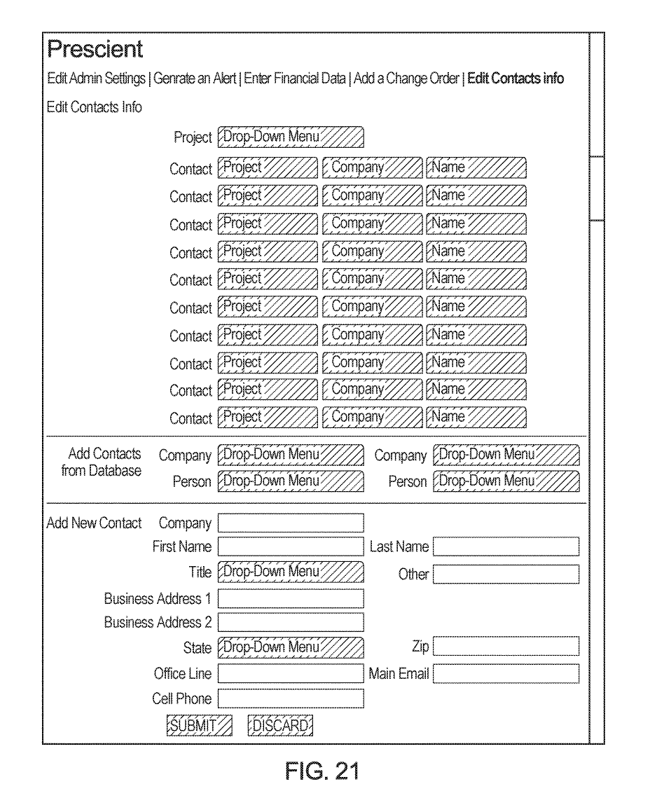

FIG. 21 is an example of a screen that enables entering or editing contacts used in certain embodiments of the system described herein. This screen preferably lets a licensee administrator edit the information that appears on the Contacts screen for a specific project run by the system. Contacts are preferably searched using a drop-down menu format. However, a search functionality may be included. In addition, data can be edited or deleted by the licensee administrator.

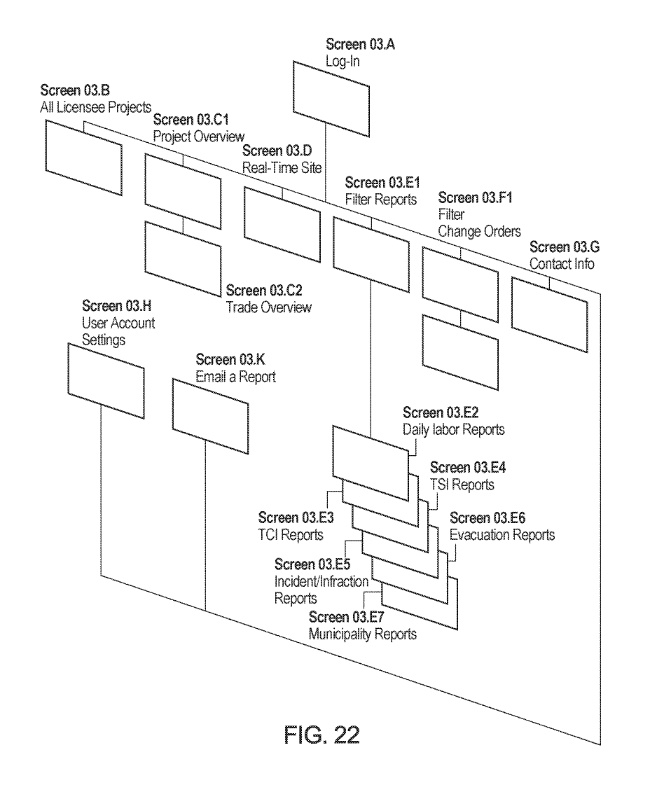

FIG. 22 is an example of web app dashboard screens used in certain embodiments of the system described herein. In a preferred embodiment, there are multiple screens that may be accessed on a web app. These may include a log-in screen; a screen showing all licensee projects; a project overview screen; a real-time site view screen; a trade overview screen; a filter reports screen; a filter change order screen; a view a change order screen; a contact info screen; a user account settings screen; an email a report screen; a daily labor report screen; a weekly report screen; a trade consistency index (TCI) report screen; an incident/infraction report screen; an evacuation report screen; and a municipality demographic report screen. Other screens may be included for some or all of the licensees.

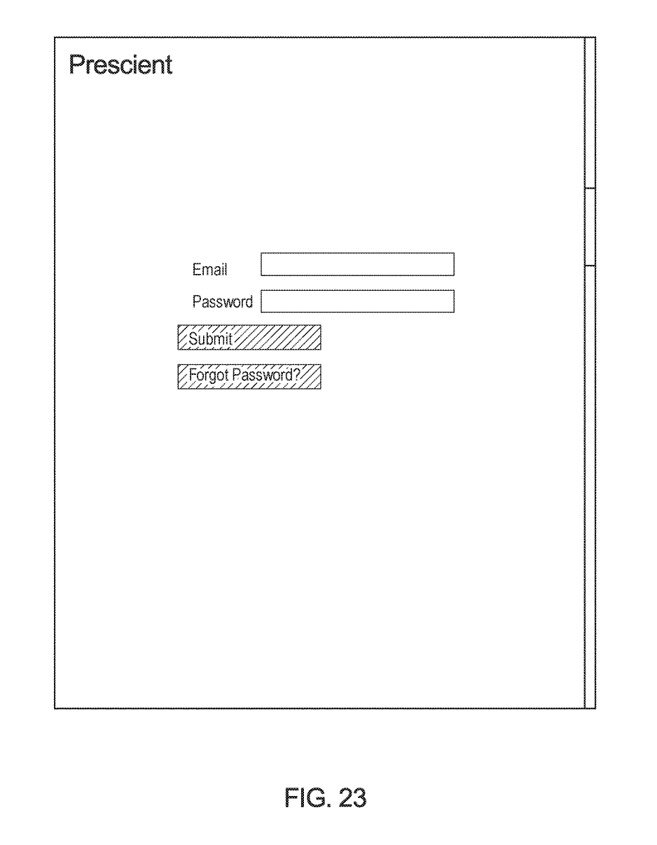

FIG. 23 is an example of a dashboard screen log-in screen used in certain embodiments of the system described herein. In one embodiment, a user may access the system using an email address instead of a unique “user name”. Alternatively, the user or the operator of the system may specify a particular user name for a given user. In another preferred embodiment, the system is password protected. In one embodiment, the initial password for a user will be generated by the operator of the system. In another embodiment, the user has the ability to change the password after initial log-in. Password recovery functionality is also preferably included.

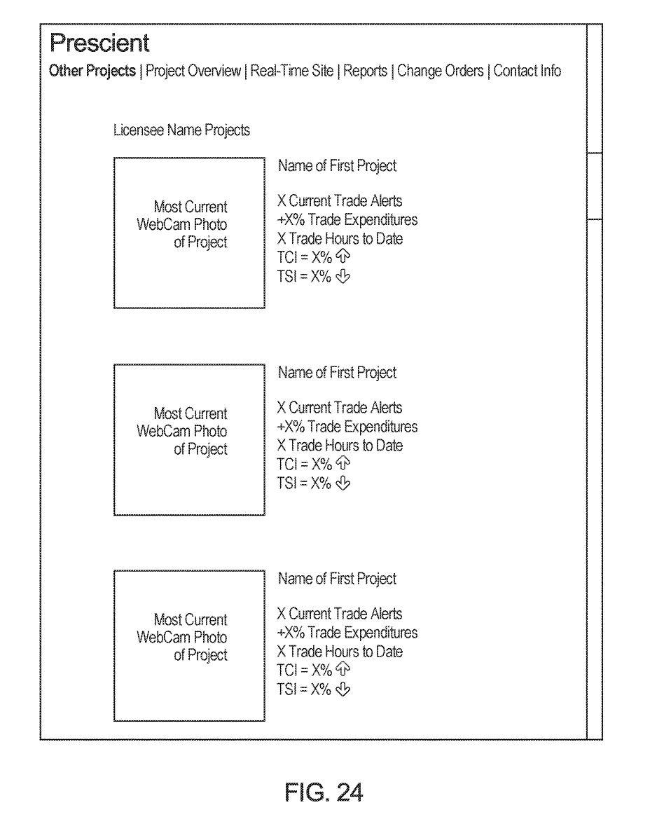

FIG. 24 is an example of a dashboard screen showing various projects of a particular user that is used in certain embodiments of the system described herein. In a preferred embodiment, this screen allows the licensee to view all of the projects in which the user is actively participating and to quickly scan for issues which may require immediate attention. A licensee will see all the projects for their company or within their control. In a preferred embodiment, this screen links to a project overview page for each particular project.

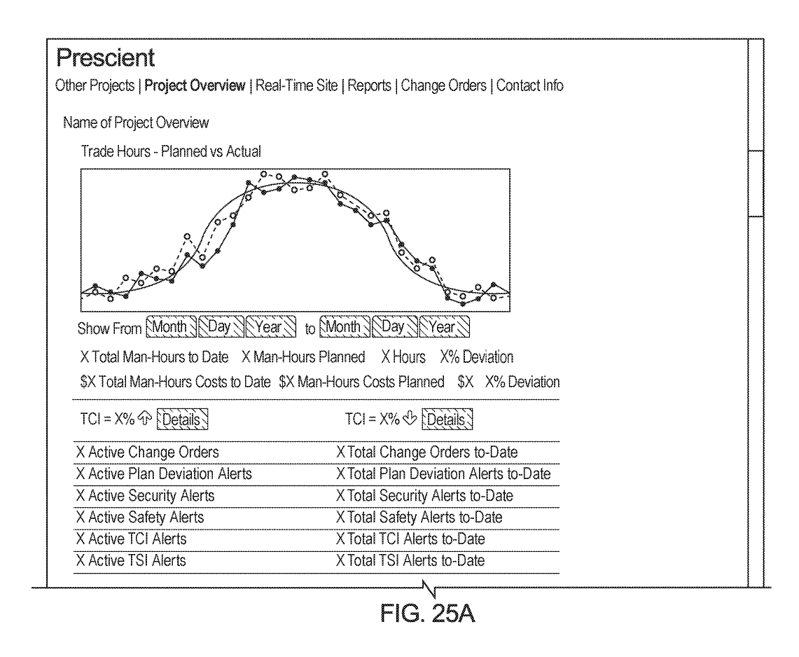

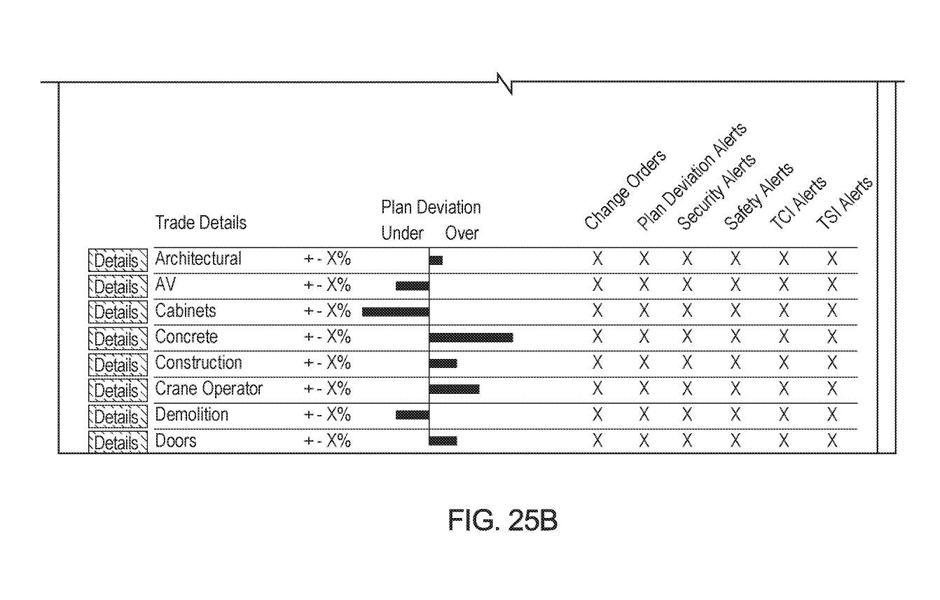

FIGS. 25A and 25B is an example of a project overview dashboard screen used in certain embodiments of the system described herein. In a preferred embodiment, this screen gives an instant overview of all of the labor trending data for a specific construction project. In another preferred embodiment, a chart on this screen may show actual hours worked on-site compared to the hours planned. In addition, any active alert for a particular project may be viewable on this screen as well as countdown clock, weather data, five day look ahead illustrating headcount, hours and weather for the following five days, the current TCI and TSI index summaries, a webcam view of the site, progress for all contract trades as well as those specific trades on the project's critical path. This dashboard view is also available for previous days dating back to the beginning of the recording of the project.

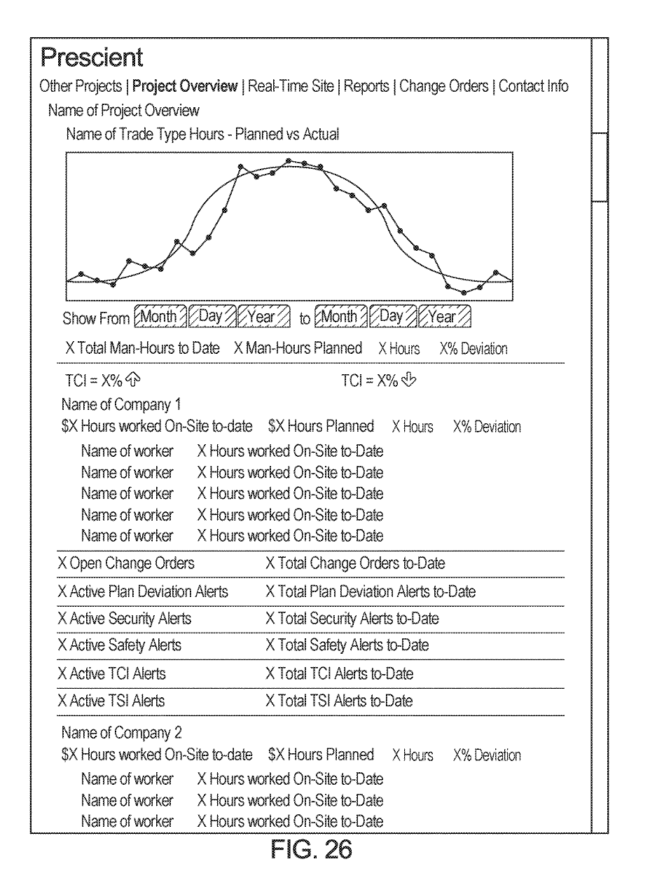

FIG. 26 is an example of a trade overview dashboard screen used in certain embodiments of the system described herein. In a preferred embodiment, this screen gives an instant overview of all of the labor trending data for a specific trade type. In another preferred embodiment, a chart shows how actual hours worked on site compare to the hours planned for that trade type.

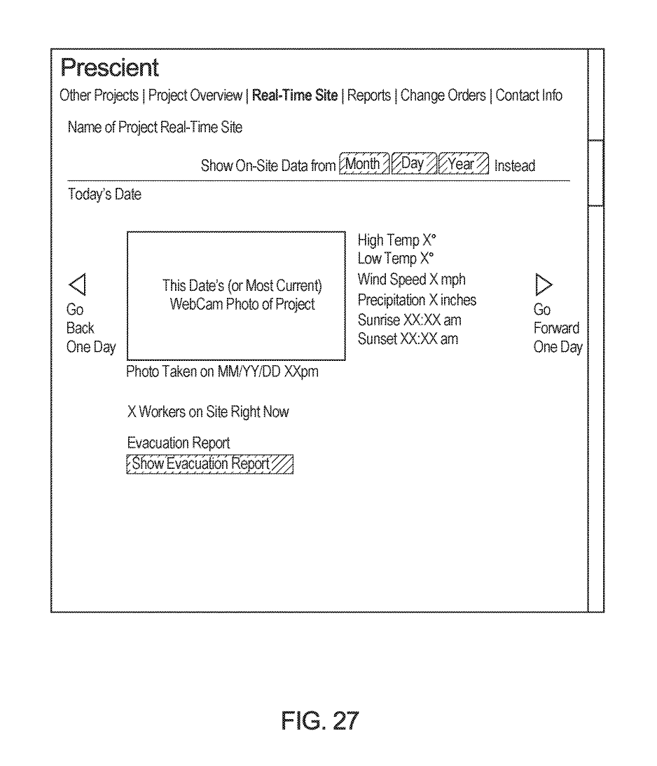

FIG. 27 an example of a dashboard screen showing a real time site used in certain embodiments of the system described herein. This screen gives an instant view of what is happening at the site in real time.

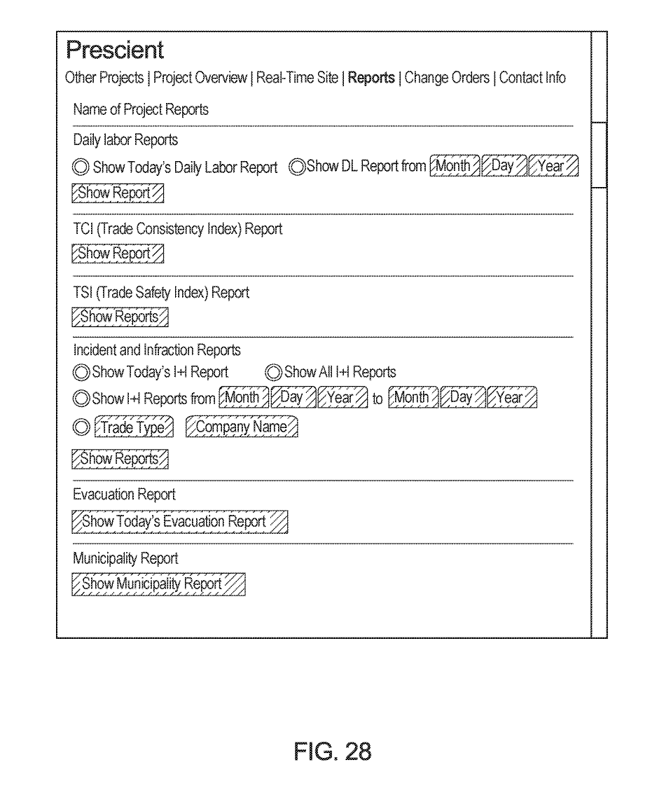

FIG. 28 is an example of a dashboard screen showing a screen permitting a user to filter reports used in certain embodiments of the system described herein. In a preferred embodiment, this screen allows the user to access all reports for this specific construction project.

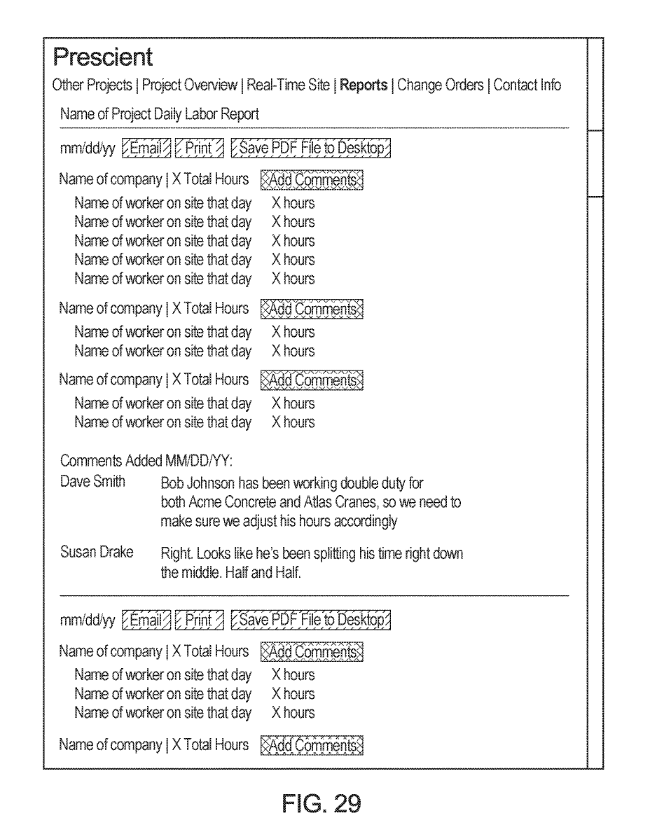

FIG. 29 is an example of a dashboard screen showing functionality used to generate a daily labor report used in certain embodiments of the system described herein. In a preferred embodiment, the daily labor report shows on-site labor hours for the day specified.

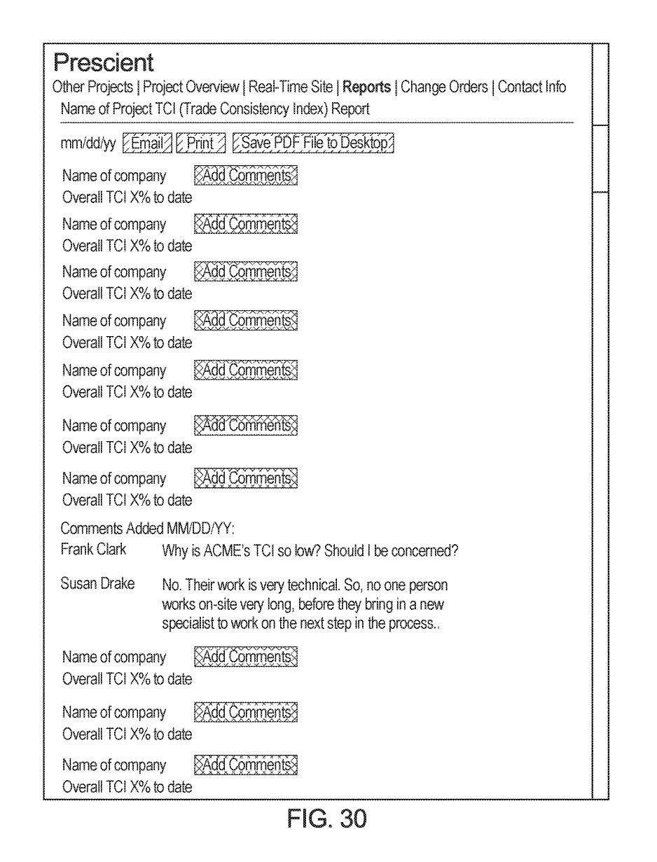

FIG. 30 is an example of a dashboard screen showing functionality used to generate a trade consistency index report used in certain embodiments of the system described herein. In a preferred embodiment, the trade consistency index report shows how consistent the on-site labor has been. The more consistent the workforce within a company, the higher the percentage. The more turnover or unique/one-time workers, the lower the percentage. The trade consistency is recorded for all workers for all trades and specifically for the trades that are considered to be on the critical path to the completion of the project.

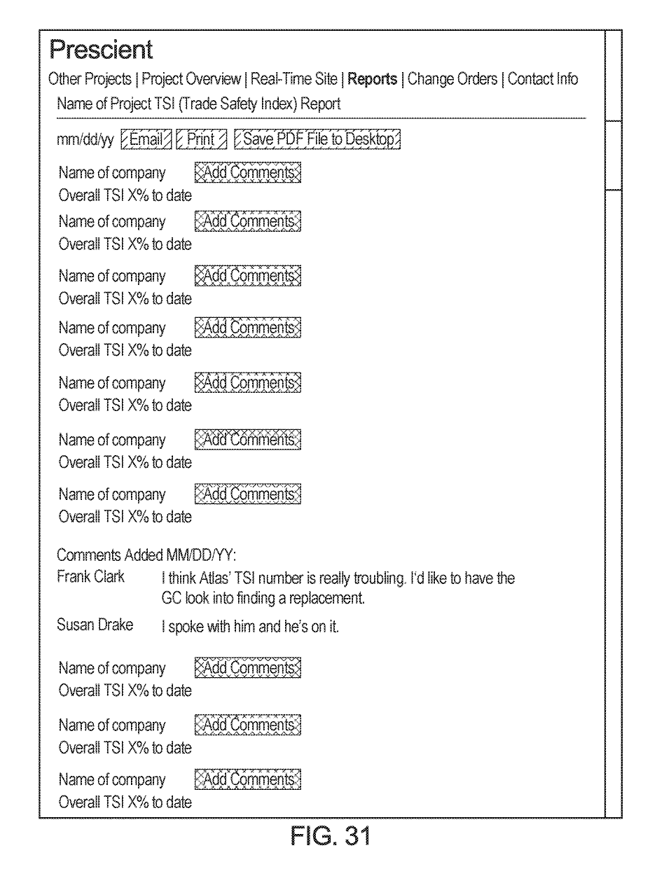

FIG. 31 is an example of a dashboard screen showing functionality used to generate a trade safety index report used in certain embodiments of the system described herein. In a preferred embodiment, the trade safety index illustrates certain safety related metrics that may be created with algorithms within the server. Alternatively, the server may import data using an Application Program Interface (API) from the server of an independent third-party safety recording and reporting system. In one type of measurement, the fewer safety infractions or incidents, the higher and better the resultant safety index. The more safety infractions or incidents, the lower or poorer the index. While impossible to achieve, in this measurement methodology, an ideal/perfect score is 100% Safety measurements imported via API from other safety systems may include colors, numbers or other illustrative measurable metrics.

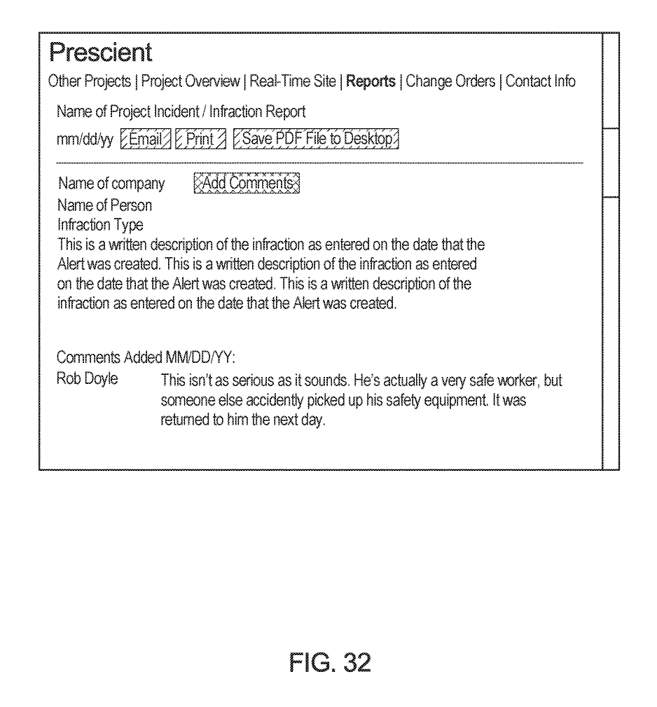

FIG. 32 is an example of dashboard screen showing functionality used to generate an incident/infraction report used in certain embodiments of the system described herein. In a preferred embodiment, the incident and infraction reports are records of safety and security incidents as entered by the operator or the licensee through the licensee data entry screens.

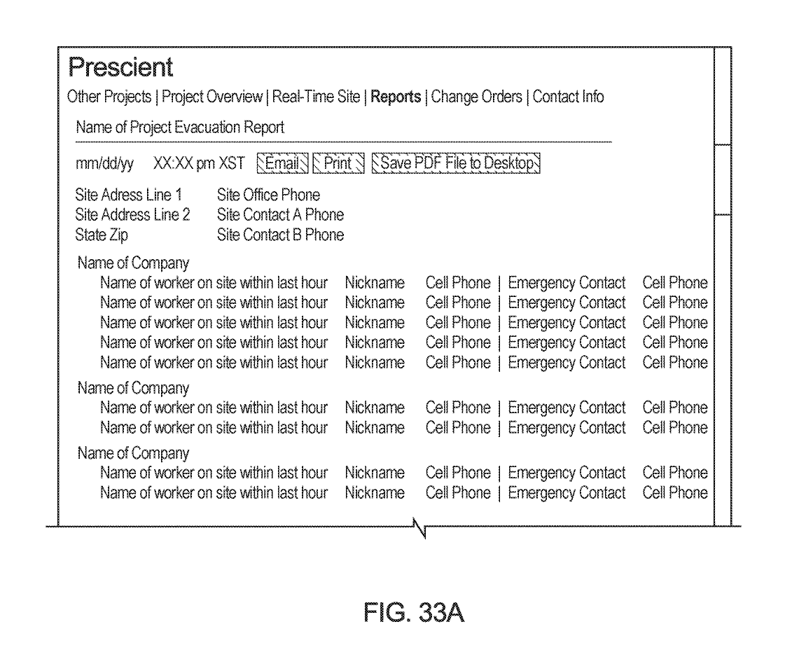

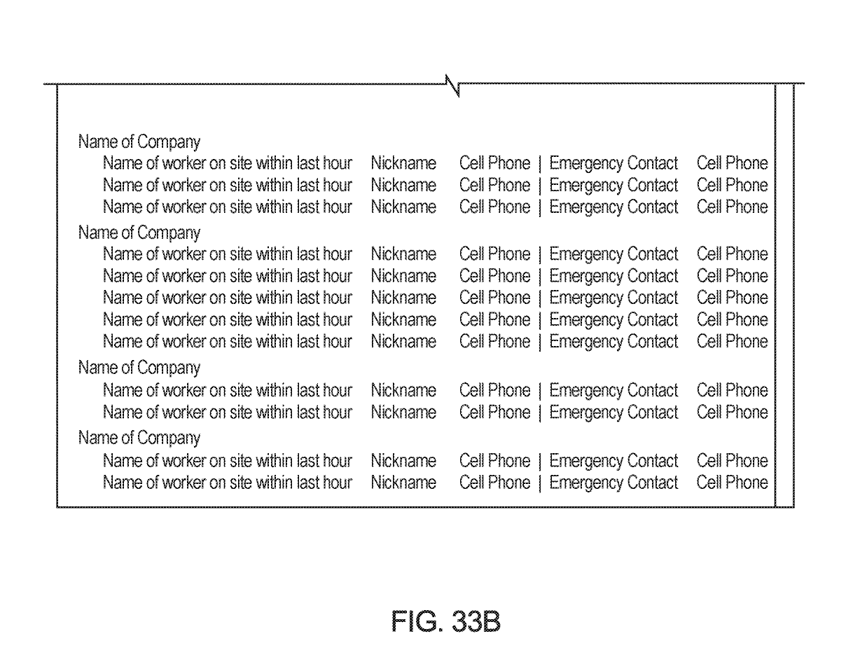

FIGS. 33A and 33B is an example of a dashboard screen showing functionality used to generate an evacuation report used in certain embodiments of the system described herein. In a preferred embodiment, the evacuation report is an aid in identifying everyone on the construction site in the event that the site needs to be evacuated for safety or security reasons.

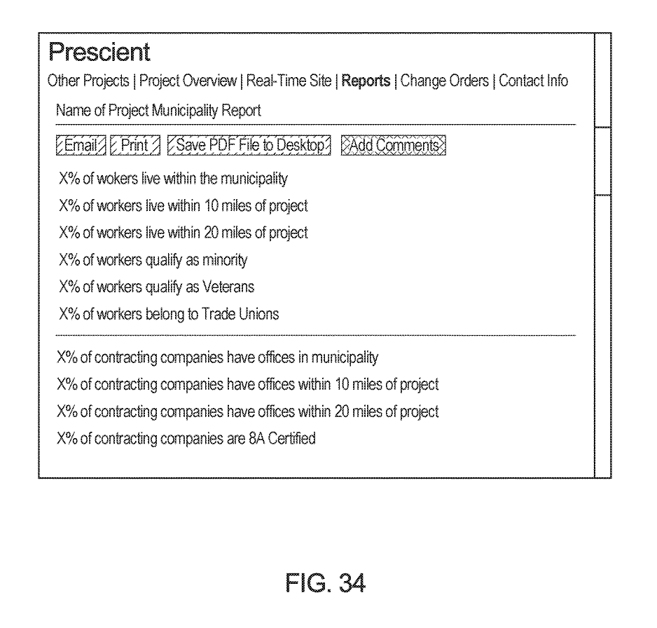

FIG. 34 is an example of a dashboard screen showing functionality used to generate a municipality workforce demographic report used in certain embodiments of the system described herein. In a preferred embodiment, the municipality workforce demographic report shows information that local, State, or Federal Governments may require to show that the site is in compliance with workforce requirements of local municipality, State, Federal, labor or union requirements.

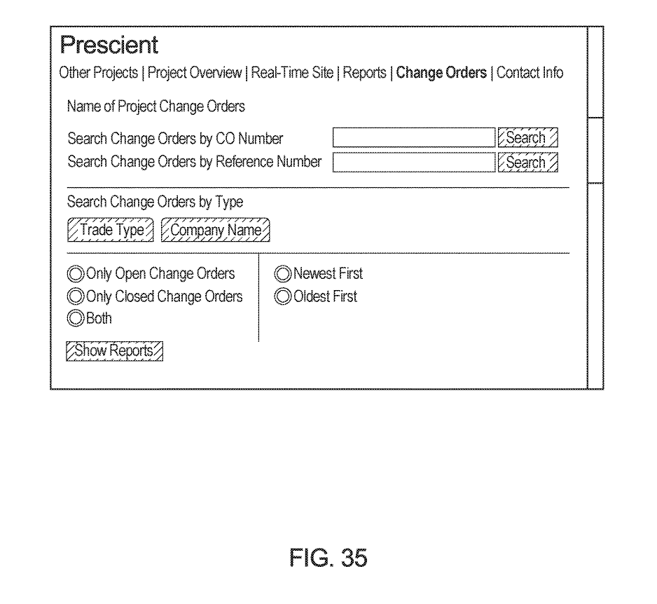

FIG. 35 is an example of a dashboard screen showing functionality used to filter change orders used in certain embodiments of the system described herein. This report allows licensees to accurately track actual on-site man-hours related to a change order.

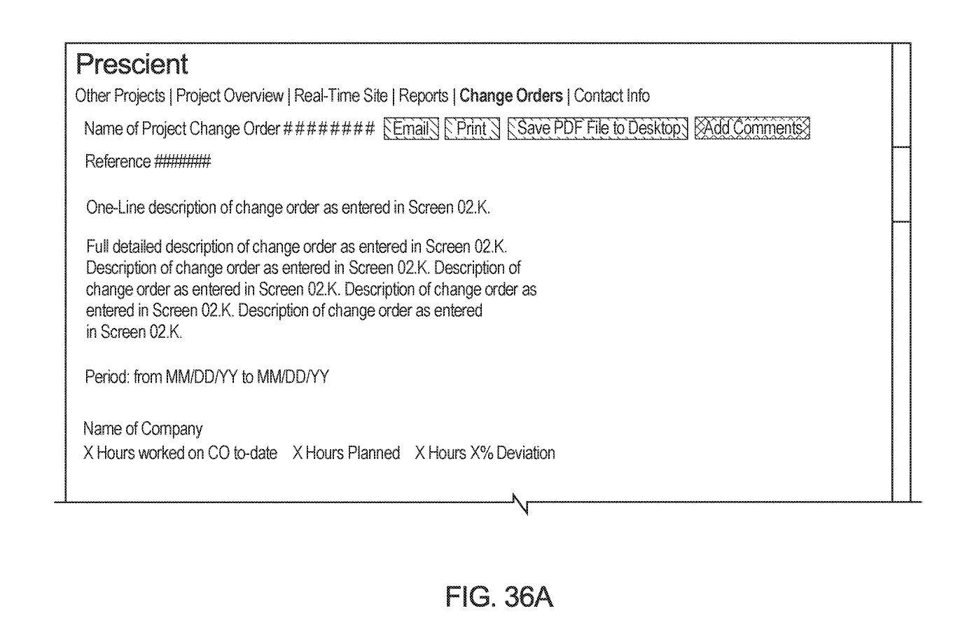

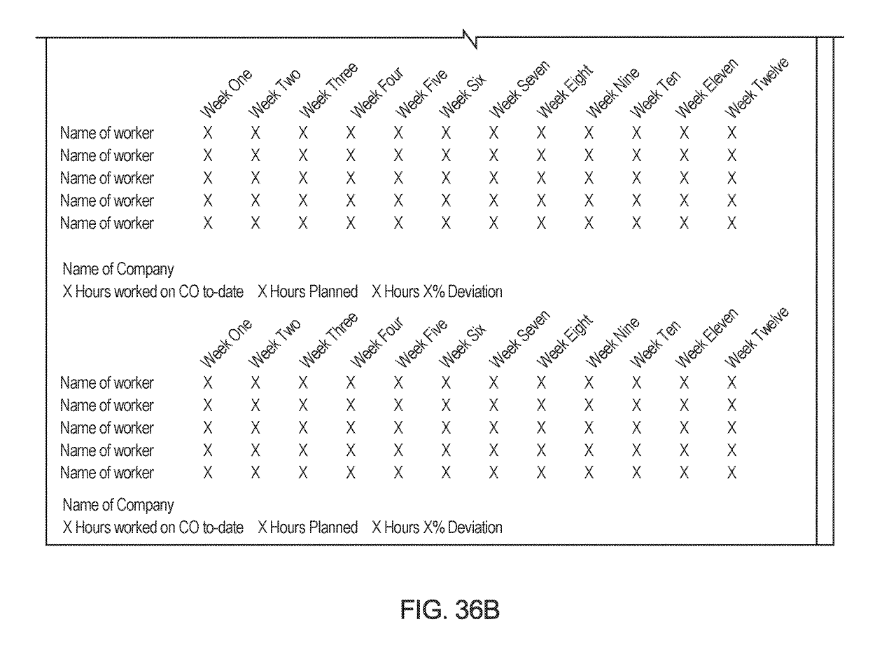

FIGS. 36A and 36B is an example of a dashboard screen showing functionality used to view a change order in certain embodiments of the system described herein. In a preferred embodiment, the screen will permit the user to email the change order, print the change order, and download a pdf of the change order.

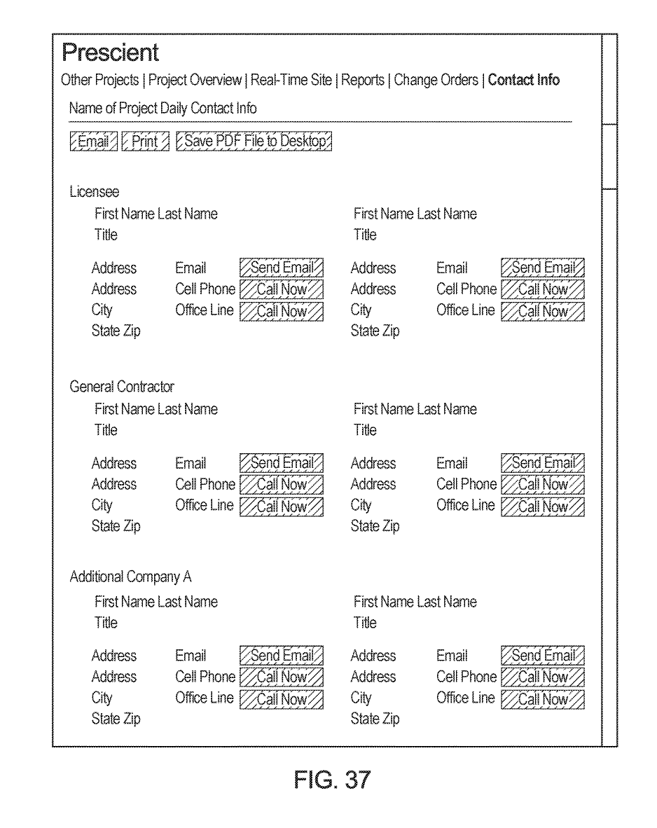

FIG. 37 is a dashboard screen showing functionality used for viewing a project's contacts in certain embodiments of the system described herein. In a preferred embodiment, this screen shows all of the contact information for a specific project.

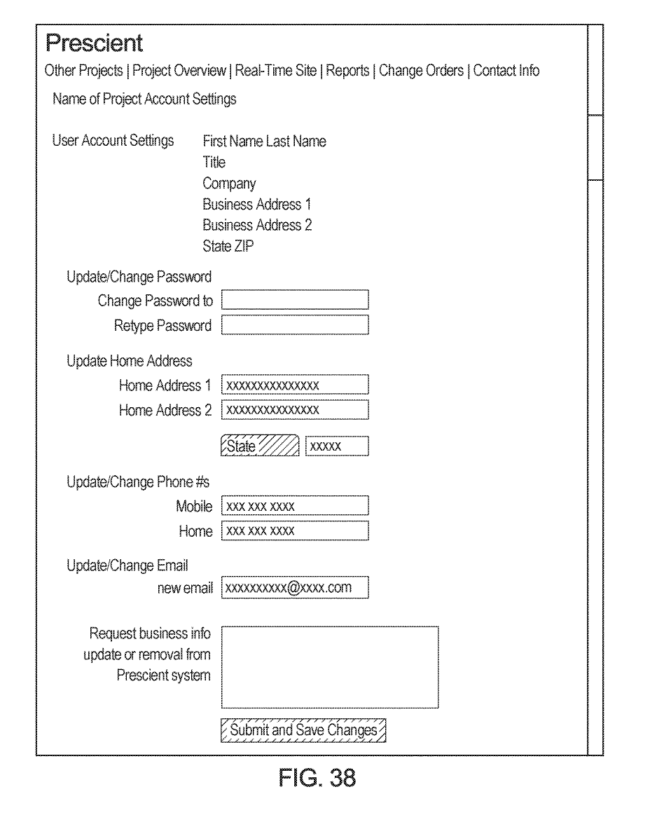

FIG. 38 is a dashboard screen showing user account settings used in certain embodiments of the system described herein. In a preferred embodiment, this screen allows users to update their personal information.

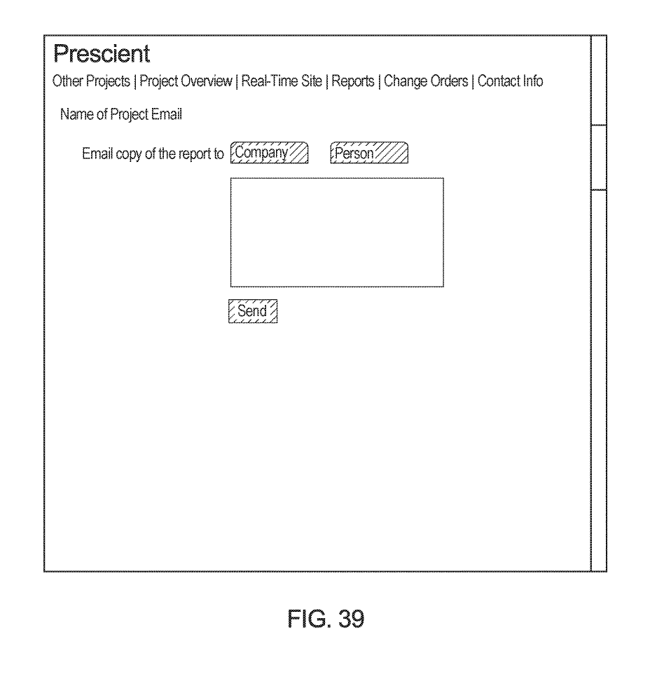

FIG. 39 is a dashboard screen showing functionality used for emailing a report that is used in certain embodiments of the system described herein. In a preferred embodiment, this screen allows a user to email a report to a registered user who is associated with this specific construction project.

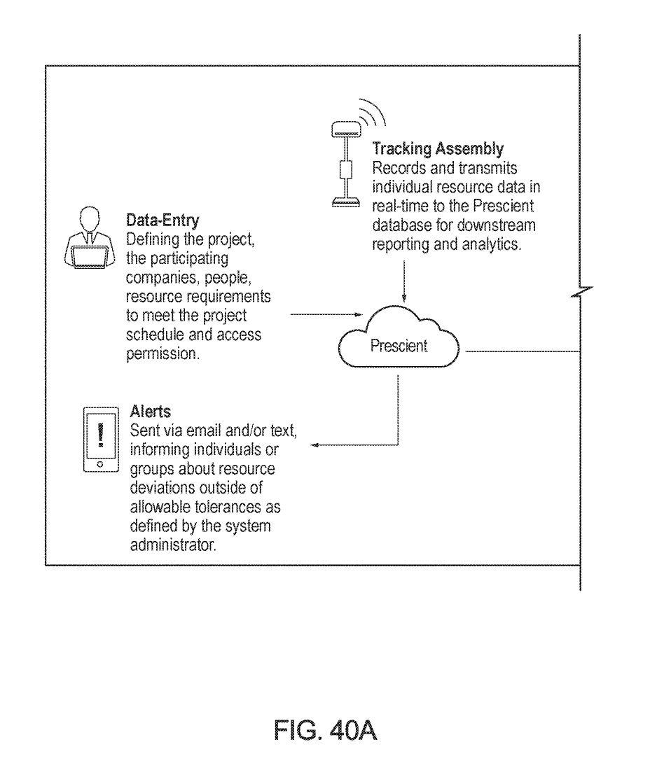

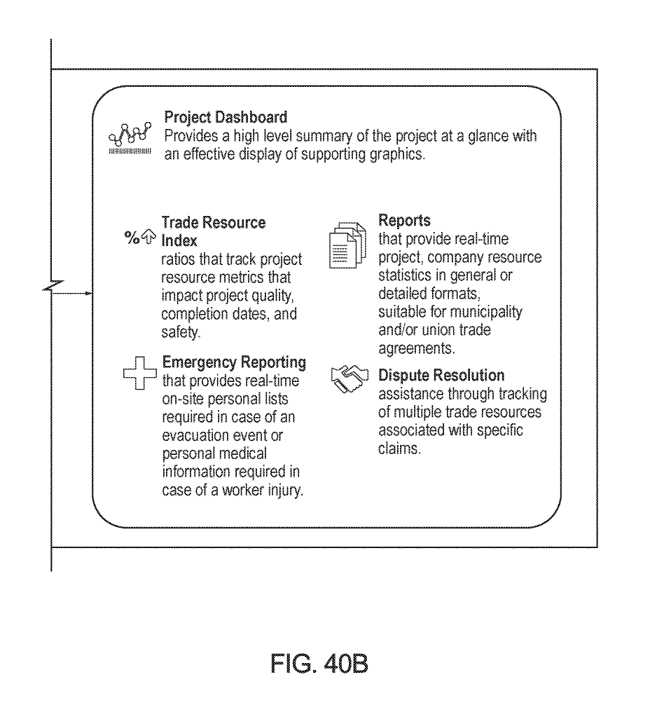

FIGS. 40A and 40B is a highlight of the functionality and operation of certain embodiments of the system described herein. In a preferred embodiment, the system takes data entered by the operator and/or licensee of the system as well as data collected by RFID scanners, Bluetooth beacons or other tracking technology at the construction site. The server processes this information to generate an alert if conditions require it. In addition, the server is able to push content to various dashboard screens as outlined above.

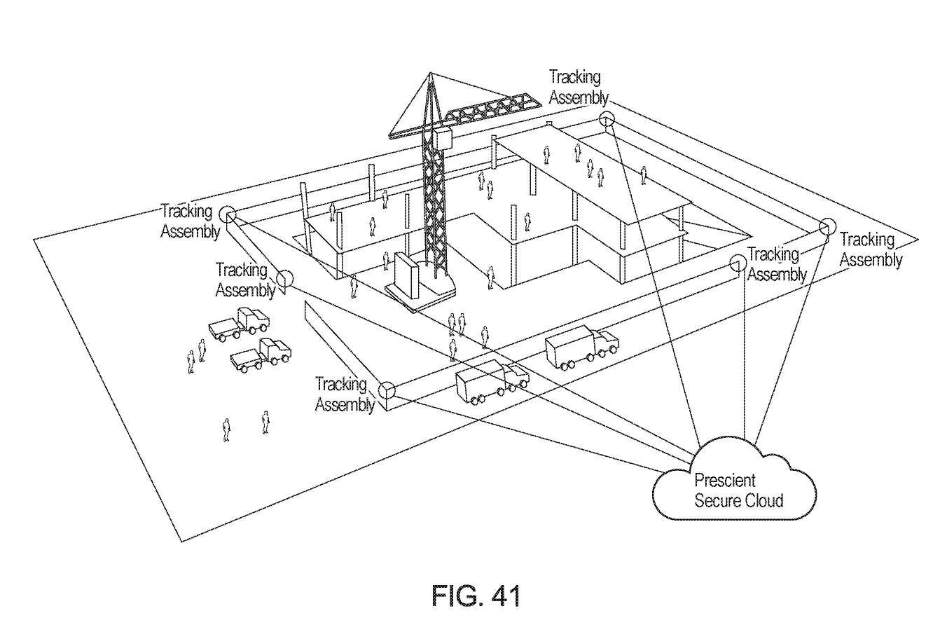

FIG. 41 is sample construction site that employs certain embodiments of the system described herein. RFID or Bluetooth readers or other tracking assemblies are located at various points around the construction site including at the points of ingress and egress. The system described herein is not to be limited to any particular tracking technology. Other tracking technologies such as Bluetooth, ultra wide band, Zigbee, or others may be used including, but not limited to, passive tags or active beacons as well as other technology that transmits without hardware (such as the readers) on site (e.g., cell-phones).

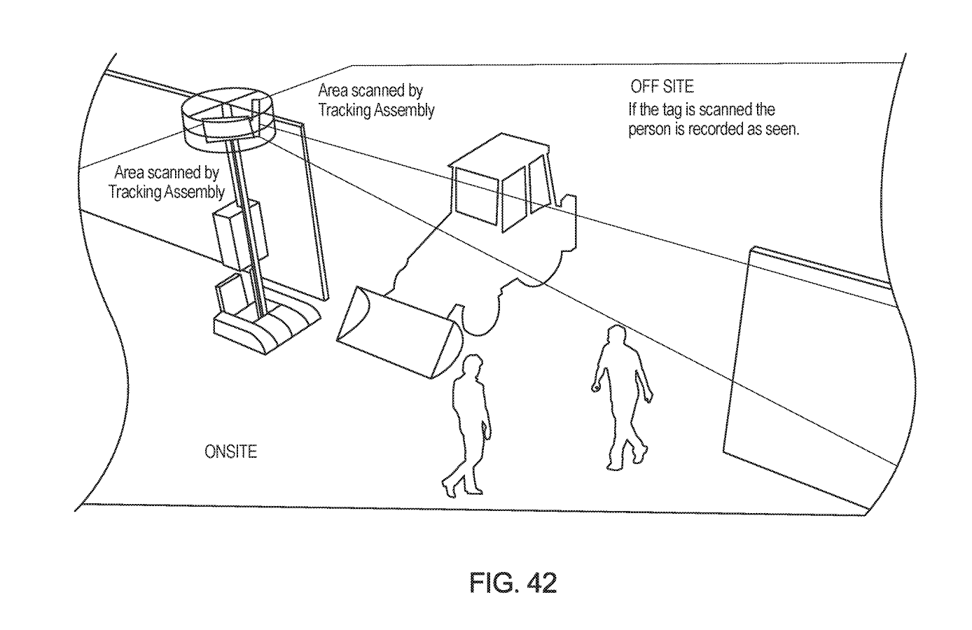

FIG. 42 is an tracking assembly positioned at a point of entrance/egress on a construction site that employs certain embodiments of the system described herein. In a preferred embodiment, the RFID or Bluetooth scanners or readers have multiple antennaes or may have none depending on the technology. In the case of a scanner or reader of some technologies located near a point of entry/egress, one antenna will detect signals in the interior of the site and another antenna will detect signals at the exterior of the site. The system can determine whether a person, object, or piece of equipment is entering or leaving the site based on the order in which the antennae detect a signal.

While exemplary embodiments are described above, it is not intended that these embodiments describe all possible forms of the invention. Rather, the words used in the specification are words of description rather than limitation, and it is understood that various changes or other technologies may be made without departing from the spirit and scope of the invention. Additionally, the features of various implementing embodiments may be combined to form further embodiments of the invention.

What is claimed is:

1. A system for tracking trade labor resources on a construction site in real-time which comprises: a construction site having one or more points of access; a tracking assembly located at each of the one or more points of access; a computing device connected to the tracking assembly wherein the computing device is connected to a communicating device for transmitting information to a server; a server located remotely from the computing device for receiving information from the computing device; at least one contract for providing construction services on a project; wherein each worker working on the project is assigned to at least one contract; wherein each worker entering the construction site is given a unique electronic identifier; wherein the tracking assembly is configured to detect the date and time at which each worker is first observed on the construction site; wherein the tracking assembly is configured to detect the date and time at which each worker is last observed on the construction site; wherein the computing device collates the information detected by the tracking assembly and transmits said information to the server; wherein the server receives the information from the computing device and processes said information; wherein the server distributes a portion of the information in real-time to a predetermined party; and wherein the server processes said information and distributes a portion of the information in real-time to compare whether the trade resources incurred on the site on a particular date or range of dates meet, exceed, or fall short of a predetermined threshold.

2. The system of claim 1, wherein the server processes said information and distributes a portion of the information in real-time to compare whether the trade resources for a specific contract incurred on a particular date or range of dates meet, exceed, or fall short of a predetermined threshold.

3. The system of claim 2, wherein the server sends a notification to a predetermined party if the trade resources on site or for a specific contract exceed the predetermined threshold by a specified amount or if the trade resources fall short of a predetermined threshold by a specified amount.

4. The system of claim 1 wherein, the server further identifies each worker who works on the project on a day to day basis so as to determine a trade consistency index.

5. The system of claim 1, wherein the server receives safety infraction and incident information and the server compares trade resource hours on a job to safety infractions to determine a trade safety index.

6. The system of claim 3, wherein the server predicts a schedule delay and the duration of the schedule delay.

7. The system of claim 3, wherein the server determines a project delay and the length of that delay based on the trade forecast requirements and the actual trade resource data collected and reported.

8. The system of claim 7, wherein the delay is communicated via an alert.

9. The system of claim 3, wherein the server determines whether a key trade person is participating on a project.

10. The system of claim 1, wherein the server provides images of workers to permit visual identification of on-site workers.

11. The system of claim 1, wherein the server maintains a directory of all workers on a project.

12. The system of claim 1, wherein the server tracks materials used on the project.

13. The system of claim 1, wherein the server tracks equipment used on the project.

14. The system of claim 1, wherein the server tracks the progress of excavation on a project.

15. A system for tracking trade labor resources on a construction site in real-time which comprises: a server located remotely from the construction site configured to receive information from an application program interface; at least one contract for providing construction services on a project; wherein each worker working on the project is assigned to at least one contract; wherein each worker entering the construction site is given a unique electronic identifier; wherein the application program interface contains information regarding the date and time at which each worker is first observed on the construction site; wherein application program interface contains information regarding the date and time at which each worker is last observed on the construction site; wherein the server receives the information from the application program interface and processes the information; wherein the server distributes a portion of the information in real-time to predetermined parties and wherein the server processes said information and distributes a portion of the information in real-time to compare whether the trade resources incurred on the site on a particular date or range of dates meet, exceed, or fall short of a predetermined threshold.

16. The system of claim 15, wherein the server processes said information and distributes a portion of the information in real-time to compare whether the trade resources for a specific contract incurred on a particular date or range of dates meet, exceed, or fall short of a predetermined threshold.

17. The system of claim 16, wherein the server sends a notification to a predetermined party if the trade resources on site or for a specific contract exceed the predetermined threshold by a specified amount or if the trade resources fall short of a predetermined threshold by a specified amount.

18. The system of claim 15, wherein the server further identifies each worker who works on the project on a day to day basis so as to determine a trade consistency index.

19. The system of claim 15, wherein the server receives safety infraction and incident information and the server compares trade resource hours on a job to safety infractions to determine a trade safety index.

20. The system of claim 17, wherein the server predicts a schedule delay and the duration of the schedule delay.

21. The system of claim 17, wherein the server determines a project delay and the length of that delay based on the trade forecast requirements and the actual trade resource data collected and reported.

22. The system of claim 21, wherein the delay is communicated via an alert.

23. The system of claim 17, wherein the server determines whether a key trade person is participating on a project.

24. The system of claim 15, wherein the server provides images of workers to permit visual identification of on-site workers.

25. The system of claim 15, wherein the server maintains a directory of all workers on a project.

26. The system of claim 15, wherein the server tracks materials used on the project.

27. The system of claim 15, wherein the server tracks equipment used on the project.

28. The system of claim 15, wherein the server tracks the progress of excavation on a project.
